(19) United States
(12) Patent Application Publication
(10) Pub. No.: US 2015/0293512 A1
(43) Pub. Date: Oct. 15, 2015

(54) METHOD AND SYSTEM FOR PROVIDING OPTIMIZATION IN DATA-DRIVEN ENVIRONMENTS

(71) Applicant: Nathan EGGE, Arlington, VA (US)

(72) Inventor: Nathan EGGE, Arlington, VA (US)

(21) Appl. No.: 14/370,018

(22) PCT Filed: Dec. 30, 2012
(86) PCT No.: PCT/US12/72238

§ 371 Date: Jun. 30, 2014

Related U.S. Application Data
(60) Provisional application No. 61/582,208, filed on Dec. 30, 2011.

(51) Int. Cl. G05B 17/02; G06F 17/50

(52) U.S. Cl. CPC G05B 17/02; G06F 17/5036

(57) ABSTRACT

An approach is provided for providing optimization in data-driven environments. An optimization platform may receive one or more database queries expressing a computation objective. The optimization platform may also determine a database model based, at least in part, on the computation objective. The optimization platform may also annotate the database model with one or more variable attributes, one or more constraints, or a combination thereof. The optimization platform may also convert the database model into one or more mathematical models based, at least in part, on the one or more variable attributes, the one or more constraints, or a combination thereof. The optimization platform may further determine one or more solutions based, at least in part, on the one or more mathematical models

### RELATED APPLICATIONS

This application claims the benefit of the earlier filing date under PCT Rule 80 and 35 U.S.C. §119(e) of U.S. Provisional Application Ser. No. 61/582,208 filed Dec. 30, 2011, entitled “Method and System for Providing Optimization in Data-Driven Environments,” the entirety of which is incorporated herein by reference.

### BACKGROUND

Computational devices such as personal computers, sensory devices, mobile devices, etc., offer various methods of connectivity and are utilized by many people and businesses, are becoming the primary gateway to the internet, a major storage point for personal and professional information, and a significant source for developing strategic business decisions. Pooling these devices, as well as applications that run by these devices and information processed by the applications is a major challenge of interoperability. Furthermore, decision optimization is widely used in many Decision Support and Guidance Systems (DSGS) to support business decisions such as procurement, scheduling, and planning. In spite of rapid changes in users' requirements, the implementation of DSGS is typically rigid, expensive and not easily extensible, which is in stark contrast to the agile implementation of management Information Systems (MIS) based on data management strategies, for example by Database Management Systems (DBMS) and SQL technologies, etc. Additionally, decision optimization is used in many applications such as those for finding the best course of action in emergencies. An increasing number of decision-guidance applications are needed to provide human decision makers with actionable recommendations on how to move a complex process toward desirable outcomes (e.g., deciding on business transactions within supply chains.)

Implementation of decision-guidance applications often involves Mathematical and Constraint Programming (MP and CP) for decision optimization and Database Management Systems (DBMS) for management of data. While database application developers find using DBMS intuitive, they typically do not have the mathematical expertise necessary for MP and CP. Furthermore, it is desirable to leverage the considerable investment in existing database applications.

### SOME EXAMPLE EMBODIMENTS

Therefore, there is a need for an approach for providing optimization in data-driven environments, such as database systems, in order to bridge the gap between Mathematical and Constraint Programming (MP/CP) with Database Management System (DBMS) programming.

According to one embodiment, a method comprises receiving one or more database queries expressing a computation objective. The method also comprises determining a database model based, at least in part, on the computation objective. The method also comprises annotating the database model with one or more variable attributes, one or more constraints, or a combination thereof. The method further comprises converting the database model into one or more mathematical models based, at least in part, on the one or more variable attributes, the one or more constraints, or a combination thereof. The method also comprises determining one or more solutions based, at least in part, on the one or more mathematical models.

According to another embodiment, an apparatus comprises at least one processor, and at least one memory including computer program code for one or more computer programs, the at least one memory and the computer program code configured to, with the at least one processor, cause, at least in part, the apparatus to receive one or more database queries expressing a computation objective. The apparatus is also caused to determine a database model based, at least in part, on the computation objective. The apparatus is also caused to annotate the database model with one or more variable attributes, one or more constraints, or a combination thereof. The apparatus is also caused to convert the database model into one or more mathematical models based, at least in part, on the one or more variable attributes, the one or more constraints, or a combination thereof. The apparatus is further caused to determine one or more solutions based, at least in part, on the one or more mathematical models.

According to another embodiment, a computer-readable storage medium carries one or more sequences of one or more instructions which, when executed by one or more processors, cause, at least in part, an apparatus to receive one or more database queries expressing a computation objective. The apparatus is also caused to determine a database model based, at least in part, on the computation objective. The apparatus is also caused to annotate the database model with one or more variable attributes, one or more constraints, or a combination thereof. The apparatus is also caused to convert the database model into one or more mathematical models based, at least in part, on the one or more variable attributes, the one or more constraints, or a combination thereof. The apparatus is further caused to determine one or more solutions based, at least in part, on the one or more mathematical models.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing optimization in data-driven environments, according to one embodiment;

FIG. 2A is a flowchart of a process for providing optimization in data-driven environments, according to one embodiment;

FIG. 2B is a flowchart of a process for providing optimization in data-driven environments based on a sub-process, according to one embodiment;

FIG. 2C is a flowchart of a sub-process for providing optimization in data-driven environment, according to one embodiment;

FIGS. 3A and 3B are scatter plots of solution time and number of variables, according to various embodiments;

FIG. 4A is a diagram illustrating a utilization of a sub-process in a machine production environment, according to one embodiment;

FIG. 4B is a diagram demonstrating a general form of an optimization problem in regard to FIG. 4A, according to one embodiment;

FIGS. 4C and 4D are graphs illustrating an approximated cost function of an assembly of machines in regard to FIG. 4A, according to various embodiments;

FIGS. 4E and 4F are graphs of experimental results illustrating speed-up using a sub-process in regard to FIG. 4A, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and system for providing optimization in data-driven environments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

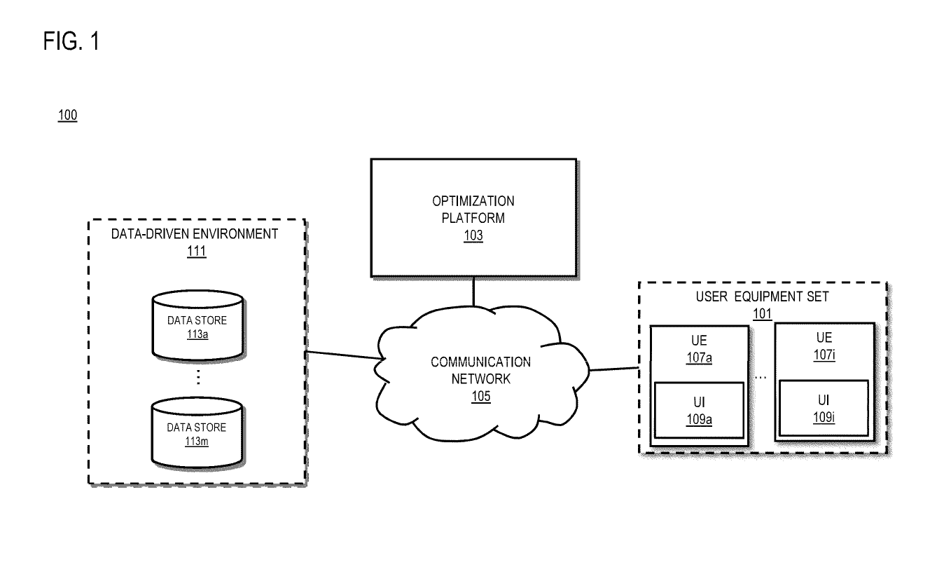

FIG. 1 is a diagram of a system capable of providing optimization in data-driven environments, according to one embodiment. In one embodiment, a Decision Guidance Query Language (DGQL) provides a query-like abstraction for expressing decision optimization problems so that database programmers would be able to use it without prior experience in MP/CP and, more importantly, to reuse the queries already built into existing applications. More specifically, DGQL allows (1) using a regular database program, in which a series of views express a computation of an objective, for example, the cost of a given supply chain; (2) annotating the program with database integrity constraints, for example, to describe business rules and limitations; and (3) indicating what columns of a database table should be found by the system to optimize the objective within the given integrity constraints.

As shown in FIG. 1, the system 100 comprises a set 101 of user equipments (UEs) 107a-107i having connectivity to an optimization platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In an embodiment, the optimization platform 103, as described, can be used with any regularly structured data in a data-driven environment 111 including data stores 113a-113m, wherein the data stores may include, but not limited to, tabular data as is described by database tables and views. In computing an intermediate value that is later used to compute an objective, data from a database 113a-113m can be mixed with that of, for example, an spreadsheet table where the variable and constraint annotations are applied and stored within the optimization platform meta-data along with all other equivalent meta-data.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 107a-107i can support any type of interface to the user (such as “wearable” circuitry, etc.).

By way of example, the UEs 107a-107i, and the optimization platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

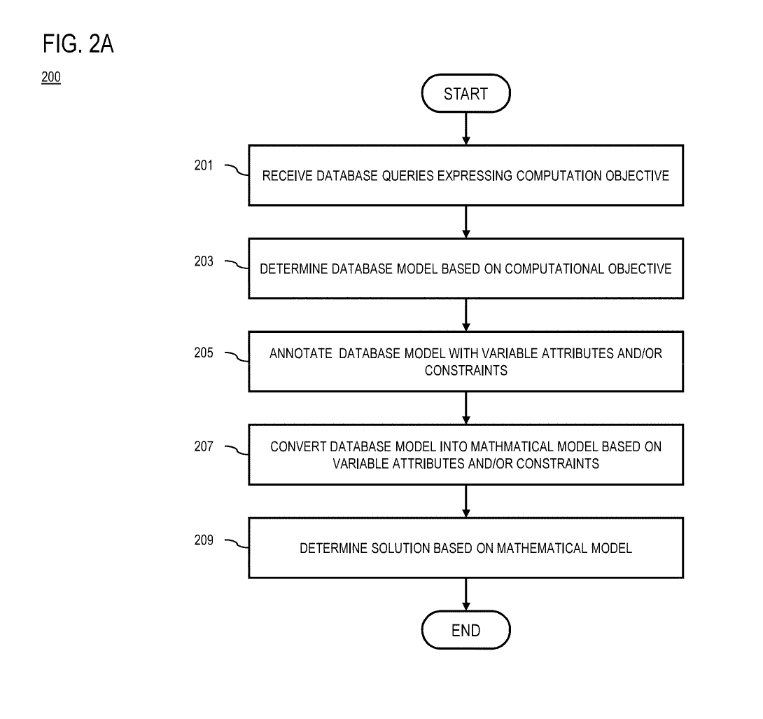

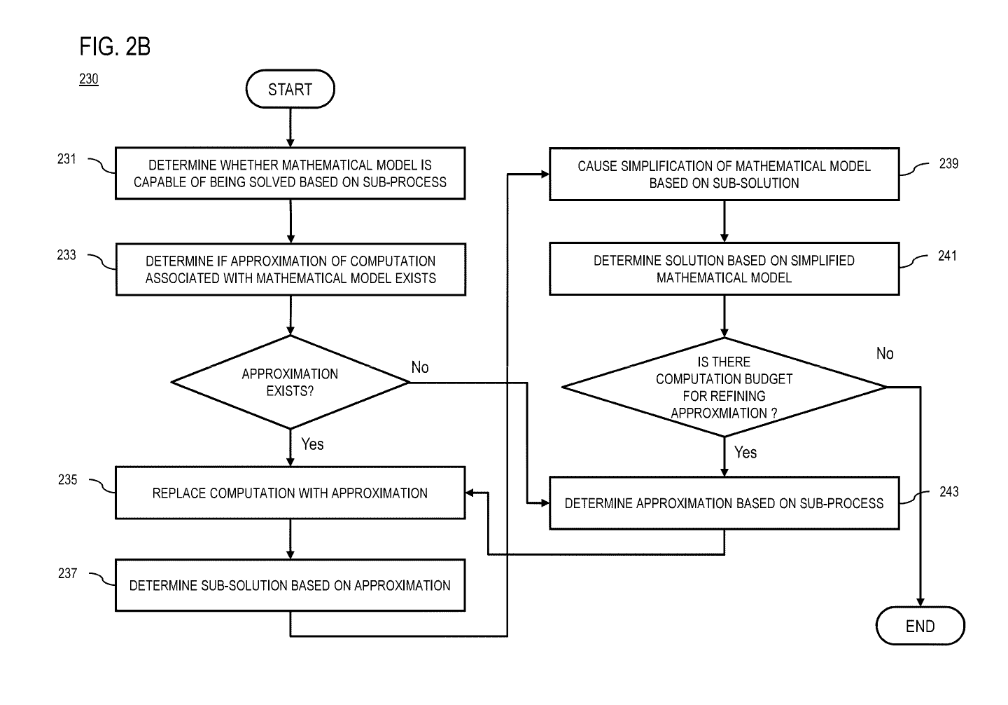

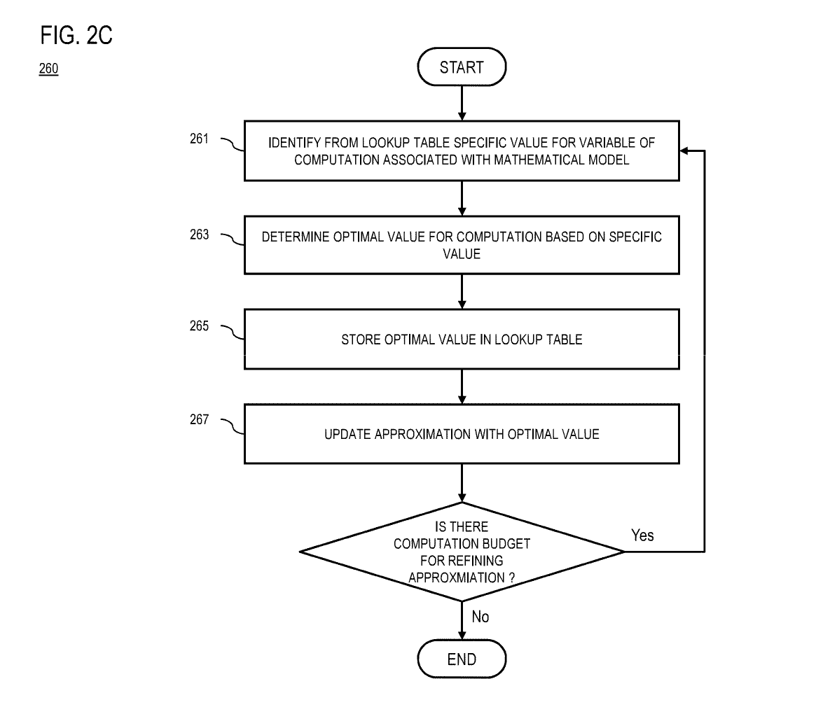

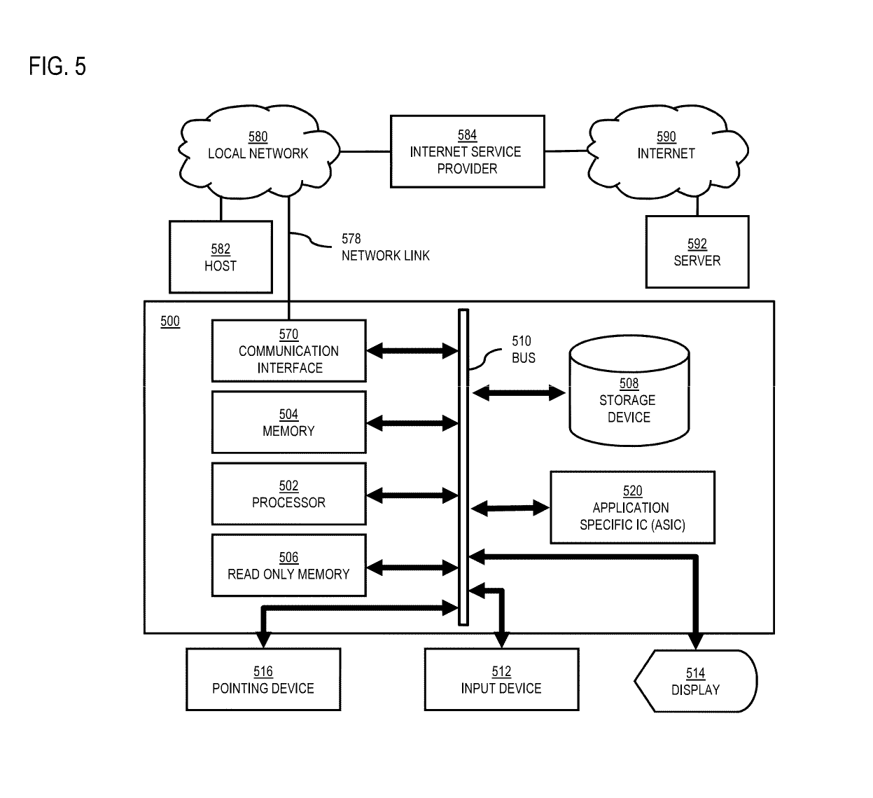

FIG. 2A is a flowchart of a process for providing optimization in data-driven environments, according to one embodiment. In one embodiment, the optimization platform 103 performs the process 200 and is implemented in, for instance, a chip set including a processor and a memory as shown in FIG. 5 and discussed below.

In step 201 (of the process 200), the optimization platform 103 may receive database queries expressing a computation objective. The database queries may be sent from the UE 101. The database queries may include codes or requests that are sent to a database to retrieve information from the database. The computation objective may include determining an optimal solution (maximized, minimized, etc.), all feasible solution that satisfies given conditions, etc. In step 203 the optimization platform 103 may determine a database model based on the computation objective. The database model may include a spreadsheet, database, a procedural computation, a program, etc. Depending on the computation objective, one or more different database models may be determined.

In step 205, the optimization platform 103 may annotate the database model with variable attributes, and/or constrains. In one embodiment, the optimization platform 103 may annotate the existing domain specific data model to indicate (1) variables and a domain the variables are over, (2) constraints that are enforced on the variables, and/or (3) (i) a single computation to be optimized (e.g., minimized, maximized, etc.) or (ii) a set of variables to be instantiated (e.g., such that all constraints are satisfied).

In step 207, the optimization platform 103 may convert the database model into mathematical model based on variable attributes and/or constraints. In one embodiment, given an input as a single value to be optimized or a set of values to be instantiated, the optimization platform 103 may analyze the data model to determine all relevant computations needed to evaluate the values involving variables and any constraints on the variables. In one embodiment, the optimization platform 103 may convert the data model from the native domain (e.g., spreadsheet, database, procedural computation, etc.) into a generic intermediate representation (e.g., mathematical model) where each node represents some computation, and the nodes are annotated to indicate that the nodes need to be instantiated and are derived in part by computations involving at least one variable.

In step 209, the optimization platform 103 may determine a solution based on the mathematical model. In one embodiment, the optimization platform 103 may perform static analysis on the intermediate model to reduce or simplify the computations needed for evaluating the optimization objective (or the set of values to be instantiated).

In one embodiment, the optimization platform 103 may simplify the mathematical models by reducing the variable attributes, rewriting constraints, removing computation s of the mathematical models. By way of example, the optimization platform 103 may rewrite computations to reduce the number of variables in the model (e.g., reordering constrains to exclude trees of computation that are known to be infeasible), (2) reduce the complexity by removing computations that may be numerically unstable (e.g., use polynomial factoring to remove divisors), or (3) rewrite constraint expressions to be simpler to evaluate (e.g., transform all constraint expressions into conjunctive normal form (CNF) and remove any clauses that are known to always evaluate true). In one embodiment, if any Boolean clauses trivially evaluate to false, the problem (e.g., mathematical model) may be infeasible and the optimization platform 103 may be able to return an error to the user.

In one embodiment, the optimization platform 103 may determine mathematical solvers (e.g., optimization technique) based on database model and/or mathematical models. By way of example, the optimization platform 103 may perform static analysis on the intermediate model to determine which optimization technique or set of optimization techniques are both appropriate for the problem and available on the current platform. This may includes additional rewriting of the model. For example, if the intermediate model contains non-linear functions, but the platform only contains linear programming solvers (e.g., Linear Programming (LP) or Mixed-Integer Linear Programming (MILP)), then piece-wise linear approximation of the non-linear portions of the problem may be used and the appropriate linear programming optimization technique maybe selected. This may involve (1) approximating computationally difficult functions (e.g., piece-wise linear approximation of a non-linear function) and/or (2) breaking the problem into a multi-step optimization problem and using nested solvers.

In one embodiment, optimization by the mathematical solvers may be performed based on user specified restraints (e.g., a solution tolerance, an execution time limit, etc.). By way of example, given an optimization technique (solver), the optimization platform 103 may perform additional analysis to determine the correct tuning of the optimization technique based on the specific instance of the problem to be solved, and user defined preferences such as (1) a solution tolerance that is used to limit the solver so that a solution is returned as soon as one is found within the solution tolerance of an estimate of the optimal value. For example, where estimated maximum objective is 10.5 and user tolerance is 1.0, the solver returns any solution with objective>=10.5-1.0). When not specified, solution tolerance may be obtained through estimating the numerical accuracy of the computation model or (2) an execution time limit that is used to make the solver to return the best feasible solution (e.g., with the highest known maximum objective) when the execution time limit has expired. Further, depending on the optimization technique (solver) selected, the user may specify an starting point to the solver when searching for solutions, by simply including the values to be used as the sample point natively in the data model, For example, if the user has domain knowledge that a good solution may be found in the neighborhood of some non-optimal but easily determined value, then the user can provide this by simply having the initial values of the variables in the data model to contain this starting point.

In one embodiment, the optimization platform 103 may convert the mathematical model into a solver specific model. By way of example, given an automatically or user selected optimization technique (solver), the optimization platform 103 may convert the generic intermediate model into a solver specific representation. This can involve solver specific modeling techniques, approximations, or native representations. For example, in a pure linear program (LP), tight bounds can be automatically extracted from the intermediate model and used in the solver specific model to describe implication via Big-M or other techniques.

In one embodiment, the optimization platform 10 may apply the mathematical solver to the solver specific model. By way of example, the optimization technique (solver) may be applied to the solver specific model which in return, may produce an optimal or near optimal solution, or optionally return information on why an optimal solution cannot be found.

In one embodiment, if an optimal or near optimal solution is found, the optimization platform 103 may: (1) translate this solution (values for each of the variables identified) from the solver specific implementation back into the intermediate representation, including any needed mathematical transformations to undo approximations, or alternate representations when creating the solver specific implementation; (2) translate the solution from the intermediate representation back into the domain specific data model representation, which may involve yet another domain transformation (e.g., integer representation into enumerated or finite domain representation, numerical type into a date range, etc.); and (3) inserting values for the variables into the original data model (e.g., inserting the instantiated values for the variables identified back into the native data format from the original domain specific data mode). In case of a spreadsheet, this may include inserting a value back into the cell that was annotated to be variable corresponding to the optimal value for this variable.

In one embodiment, if the optimization technique is unable to find an optimal or near-optimal solution (i.e., feasible but non-optimal solution), the optimization platform 103 may be able to provide a specific explanation. For example, a minimal set of constraints and variables may be infeasible when they are taken together such that there is no possible solution that does not violate the constraints. In such a scenario, the optimization platform 103 may: (1) translate the minimal set of variables and constraints that demonstrates the infeasibility of the problem, from the solver specific representation to the intermediate representation; (2) translate the minimal set of variables and constraints that demonstrates the infeasibility of the problem, from the intermediate representation into the domain specific data model representation; and (3) display a human readable error message to the user that the solution is infeasible and describing to the user why it is infeasible in terms of the domain specific data representation variable names (e.g., a constraint required that 10 units of product A be purchased, but only 5 were available).

FIG. 2B is a flowchart of a process for providing optimization in data-driven environments based on a sub-process, for example, a pre-process, according to one embodiment. In one embodiment, the optimization platform 103 performs the process 230 and is implemented in, for instance, a chip set including a processor and a memory as shown in FIG. 5.

In step 231 (of the process 230), the optimization platform 103 may determine whether the mathematical model is capable of being solved based on the pre-process. The pre-process may be associated with approximations of computations associated with the mathematical model. By way of example, given a generic intermediate representation of an optimization problem (e.g., minimization, maximization, etc.), the optimization platform 103 may perform an analysis to determine if the optimization problem is of a form that allows for pre-processing. For example, the optimization platform 103 may determine whether the optimization problem contains one or more components as defined by a small set of interface variables that encapsulate a moderate number of internal variables where the large combinatorics (and highly complex computation) of the internal variables can be approximated by a much simpler function with lower combinatoric (and thus computational) complexity.

In step 233, the optimization platform 103 may determine if an approximation of the computation associated with the mathematical model exists. By way of example, the optimization platform 103 may search into an approximation table or a lookup table for approximations of the components of the optimization problem. The approximation may include approximated values of the components, the interface variables, and/or the internal variables.

If the approximation exists, the optimization platform 103 may replace the computations with the approximations (step 235) and determine sub-solutions based on the approximations (step 237). The optimization platform 103 may cause a simplification of the mathematical model based on the sub-solutions (step 239). Then, an optimal solution can be determined based on the simplified mathematical model (step 241). In one embodiment, the optimization platform 103 may take identified components and may load the existing approximation of the component (replacement variables and constraints) from a previous approximation. Further, the optimization platform 103 may replace all components from the original generic intermediate representation with the best known approximations for each component, reducing the computational complexity of solving the original optimization problem but also reducing the accuracy as the approximated problem will only give an approximately (and not provably) optimal answer. In one embodiment, the optimal solution may be further optimized by repeating steps 235-241. The steps 235-241 may be repeated as long as there is remaining computation budget (e.g., execution time limit) for refining the approximations. The approximations may be refined/determined based on the sub-processes (step 243).

If the approximation does not exist, the optimization 103 may generate/determine the approximation based on the sub-process (step 243). For example, if no approximation exists, the optimization platform 103 may generate a coarse approximation of the component by running the approximation with a small portion of the overall computation budget.

In one embodiment, using the approximated intermediate representation of the original optimization problem, the optimization platform 103 may produce an optimal or near-optimal solution (set of values for variables) that solves the approximated optimization problem. Note that there may be some optimization techniques that will produce near-optimal (feasible but not optimal) solution. When these techniques are selected by the optimization platform 103, the intermediate near-optimal solutions may be run through the same process (below) over and over to produce near-optimal feasible solutions to the original optimization problem. For time-critical decision making processes (e.g., route planning, manufacturing logistics, stock orders, etc.) having timely near-optimal solutions may be better than optimal solutions that take longer to produce. The adaptability of this algorithm to these use cases may set the tradeoff parameters automatically or through user intervention.

In one embodiment, the approximated solution found may (but not necessarily) correspond to a solution to the original optimization problem. This may be not a full solution to the original optimization problem because no value has been provided for the encapsulated internal variables of the approximated components. A full solution to the original optimization problem may be found by using the values of the interface variables of each approximated component, to index a look-up table generated in a pre-processing that contains known good combinations (values) of internal variables that produce specific values of the interface variables. The values of the internal variables are then set based on those stored in the lookup table, and a full solution to the original problem is returned.

In one embodiment, when the approximated solution found does not directly correspond to a solution in the original optimization problem (due to the fact that the values of the interface variables in the approximated solution are not exact because the component approximation is not exact) it may not be possible to directly produce a solution to the original problem. Instead, the lookup table may be used, in a similar fashion as above, to set values for the internal variables of each component, by taking advantage of the lookup table generated during the pre-processing. The values for the interface variables are then discarded, and a new reduced complexity optimization problem is produced where the large combinatorics of the components are now fixed (based on the values in the look up table) and the only variables left are the interface variables. This reduced complexity optimization problem produces valid (feasible) solutions to the original optimization problem, and its accuracy (how close an optimal solution to the reduced complexity optimization problem is to the optimal solution of the original problem) is determined by how good the component approximation is. The reduced complexity optimization problem is then run through the step 209 to produce an optimal or near-optimal solution to the original problem.

In one embodiment, the solution may be optimized by repeating the determining of the solution based on user-specified restraints. For example, if the solution to the original optimization problem produced is within the solution tolerance, the solution may be return to the user. Otherwise, if there is additional computation budget left, it may be used to refine the component approximations.

In one embodiment, given a set of components and an existing pre-processing lookup table (for each component) that contains known optimal values of the internal variables (for each component) that produce specific values of the interface variables (for each component), the pre-process may refine the lookup table by searching for additional optimal values of the internal variables (for each component) for other specific values of the interface variables.

FIG. 2C is a flowchart of a sub-process, for example, a pre-process for providing optimization in data-driven environment, according to one embodiment. In one embodiment, the optimization platform 103 performs the process 260 and is implemented in, for instance, a chip set including a processor and a memory as shown in FIG. 5.

In step 261 (of the process 260), the optimization platform 103 may identify, from a lookup table, specific values for variables of a computation associated with the mathematical model. For example, the optimization platform 103 may identify specific values of the interface variables for a component in the lookup table. There may be different metrics to use when evaluating a specific point (values for the interface variable) depending on the component itself. In various embodiments, a measure that trades off between looking for new novel good combinatorial solutions (feasible values for the internal variables) and refining the existing known good combinatorial solutions more accurate may determine the conditions when changing from one set of internal variables s to another is optimal.

In step 263, the optimization platform 103 may determine an optimal value for the computation based on the specific values. For example, given a specific set of values for the interface variables, the optimization platform 103 may produce optimal values of the internal variables. In steps 265 and 267, the optimization platform 103 may store the optimal value in the lookup table and update the approximation with optimal value. For example, the optimization platform 103 may record these values in the lookup table, and update the component approximation (if necessary) to include the additional information learned through sampling the components solution space, and continue refining the approximation by iterating steps 361-367 while there is more computation budget for the pre-processes.

In one embodiment, the solution may be optimized by repeating the determining of the solution based on user-specified restraints. By way of example, if the execution time limit has not been exceeded, use the refined component approximations of the original optimization problem may be used to look for better solutions to the original problem.

In one embodiment, a Decision Guidance Query Language (DGQL) framework is provided. With DGQL, decision optimization is accomplished easier and more agile, especially in applications where database technology has been heavily used. Briefly, DGQL provides a query-like abstraction for expressing decision optimization problems so that database programmers could use it without prior experience in MP/CP, and more importantly, so that they could reuse SQL programs already built into existing MIS.

In one exemplary embodiment, decision guidance is provided to support an emergency response (ER) officer who commands a relief operation for a natural or man-made disaster is provided. The ER officer is in charge of providing ER locations with items such as food, water, blankets, medical supplies, etc. In this embodiment, a database may be set up with the following:

| | |
|---|---|
| demand (erloc, item, | a tuple indicating that for |
| requested): | the ER location erloc, the quantity |
| | requested of item is needed. |
| supply (vendor, item, | a tuple indicating that a vendor |
| price per unit, available): | can provide at most available |
| | quantity of item at the price per unit. |
| orders (vendor, item, | a tuple indicating the order of item in |
| erloc, quantity): | quantity quantity from vendor |
| | to be sent to location erloc. |

In one embodiment, considering the above example, a reporting system may have the following query to provide total_cost information:

| | |
|---|---|
| CREATE VIEW total_cost AS | (1) |

```
  SELECT SUM (s.price_per_unit * o.quantity) AS total
  FROM orders o INNER JOIN supplier s
  ON o.vendor = s.vendor AND o.item = s.item;
```

In one embodiment, the query (1) assumes that the item orders are decided elsewhere, and the database is simply to record these orders. However, considering the situation that the ER officer needs to decide these orders, with the objective of minimizing the cost. In this embodiment, in addition to having the minimum cost, the orders must be such that all of the ER needs from the demand table are satisfied. This latter assumption can be checked by the database with the following database view:

| | |
|---|---|
| CREATE VIEW requested_vs_delivered AS | (2) |

```
  SELECT o.erloc, o.item, SUM(o.quantity) AS delivered, d.requested
  FROM orders o INNER JOIN demand d
  ON o.erloc = d.erloc AND o.item = d.item
  GROUP BY o.erloc, o.item, d.requested
  CHECK delivered >= requested;
```

It is noted that, each row of query (2) computes the total quantity of items delivered to an ER location and the CHECK integrity constraint ensures that this amount is at least as much as the quantity requested at that location. The queries provided are pure SQL programs that run in an existing DBMS 111.

In one embodiment, optimization to the SQL programs (1) and (2) are introduced by way of auxiliary SQL-like statements and annotations. The resulting annotated SQL program is referred to as a Decision Guidance Query Language (DGQL) program.

In one embodiment, the given database table orders previously introduced, can be replaced with a database view created by the a SQL statement plus an AUGMENT annotation:

| | |
|---|---|
| CREATE VIEW orders AS | (3) |

```
  AUGMENT (SELECT d.erloc, s.vendor, s.item
      FROM demand d LEFT OUTER JOIN supplier s
    ON d.item = s.item)
  WITH INTEGER quantity >= 0;
```

In one embodiment, the nested query (3) is a standard SQL query, giving all possible parings of vendor with item for each emergency location, while the view creation is a DGQL annotation that indicates the resulting table of the nested query is to be augmented with an extra column quantity that must contain non-negative integer values.

In one embodiment, the objective is explicitly specified in DGQL by using the following SQL-like statement:

MINIMIZE total_cost; (4)

The semantics of statement (4) creates a table for orders (in general, all augmented tables are instantiated) in which the last column is filled with integer values such that the total_cost is minimum among all possible orders and all the emergency demands are satisfied.

In an embodiment, when translating the optimization problem given by the MAXIMIZE/MINIMIZE or SATISFY commands, the optimization platform 103 will “step into” additional structured data repositories incorporating the syntax and semantics of the data environment (e.g. cell references, formulas, functions, data encodings, etc. from the Spreadsheet context) to seamlessly incorporate different computational paradigms into a single optimization problem. Other data-driven environments (contexts) may include, but are not limited to, flat files, web services, XML files, programming languages, stored procedures, spreadsheet files, scripting languages, declarative business rules, expert systems, etc. The same variable and constraint annotations are still applied by the optimization platform 103 within the data-driven environment 111 in order to create a unified optimization model.

In one embodiment, a DGQL query can be formally considered as a sequence of database relations (tables and views) R₁, . . . , Rₙ, wherein Rₙ is the computation of some objective function and each Rᵢ (1<=i<=n) references only tables and views in R₁, . . . , Rᵢ₋₁.

In one embodiment, an assignment of values to augmented variables creates materialized relations r₁, . . . rₙ and defines an execution path or execution tree that deterministically computes the objective function. It is noted that an execution path is feasible if for all materialized views rᵢ, the CHECK condition(s) hold true for each row in rᵢ.

In one embodiment, evaluating a DGQL query consists of selecting an assignment of variables such that the execution path is feasible and the computed objective is optimal over all feasible execution paths. It is noted that, the optimal execution path need not be unique or even exist.

In one embodiment, a reduction procedure is provided that translates any DGQL query into a mathematical programming (MP) formulation. The reduction uses a symbolic formation to represent the DGQL query, assuming that every relation has a globally unique tuple identifier “tid”.

In one embodiment, each relation Rᵢ is replaced by a materialized symbolic table sᵢ that is identical to Rᵢ except that (1) all augmented attributes have been replaced by symbolic attributes and (2) an additional symbolic attribute TAF (Tuple Action Flag) over the domain {T rue, False} is added, wherein the TAF attribute indicates whether the particular tuple exists in the materialized relation in a feasible execution path.

TABLE 1

| tid | erloc | vendor | item | quantity | TAF |
|---|---|---|---|---|---|
| 1 | Washington | Acme | widget | quantity[1] | TAF[1] |
| 2 | Lisbon | Acme | sproket | quantity[2] | TAF[2] |

Table 1 is a symbolic representation for augmented view orders with two augmented attributes quantity and TAF, according to one embodiment. In one embodiment, each symbolic attribute value (e.g., quantity[1] or TAF[2]) represents a constrained variable and is added to a set V of decision variables. Additionally, symbolic attributes that are the results of computation involving other symbolic attributes are represented using an equality constraint and this equation is added to a constraint store C.

In one embodiment each CHECK constraint in a view creation (e.g. above query (2)) is interpreted as a mathematical equation and is added to the constraints store C. Finally, constraints for the TAF attribute are added to C. For example, if the definition of the view (2) contains the redundant SQL fragment WHERE delivered>=0, the constraint TAF[1]=(delivered[1]>=0) would be added to C. Thus, the output of this reduction procedure on the DGQL query R₁, . . . , Rₙ is the set of symbolic tables s₁, . . . , sₙ and the variables V and constraints C, wherein the sets V and C are used with an MP solver (e.g. an external MP solver) and its output along with the symbolic tables s₁, . . . , sₙ completely describe the solution as a set of materialized relations.

It is noted that a decision optimization problem can be viewed as an “inverse” of the reporting problem. For example, a report may tell the total_cost of a certain supply chain given the various sourcing and transportation options used, while the corresponding optimization problem can be to select among all possible sourcing and transportation options to minimize the total_cost. Reusing existing reporting queries for decision optimization will achieve the dual goals of taking advantage of past investments and of making decision optimization more intuitive. In order to realize these goals, the system 100 of FIG. 1 addresses two related technical issues associated with a decision guidance query language (DGQL) framework. The first is to annotate existing queries to precisely express the optimization semantics, and the second is to translate the annotated queries into equivalent mathematical programming (MP) formulation that can be solved efficiently.

In one embodiment, the DGQL framework is built based on the fact that database languages are intuitive to use for reporting purposes, and decision optimization in principle is an “inverse” of much of the reporting functionality in place. In addition, code used in reporting functions often contains business logic that is needed in the decision optimization tasks. Based on this observation, a decision optimization problem in DGQL is written as a “regular” database program, for example, a sequence of relational views and accompanying integrity constraints, together with some annotation of which database table column needs to be decided by the system (e.g., variables) and toward what goal (e.g., optimization objective). The existing queries in the reporting software can be directly used. Essentially, DGQL allows users to write optimization problem as if writing a reporting query in a forward manner.

In one embodiment, the “inverse” decision optimization is executed based, at least in part, on a “forwardly” expressed code by encoding the DGQL queries as an MP formulation, and by solving the MP problem and then deriving the solution to the DGQL optimization problem.

In one embodiment, DGQL has the potential to achieve the best of both easy development and efficient systems for decision guidance. In terms of efficiency, the overall performance of intuitive DGQL queries compare squarely with expert-generated MP problems.

In one embodiment, DGQL extends the most broadly used database query language SQL and adds only a minimal annotation which allows translation of SQL queries into optimization problems. As a result, DGQL does not require database programmers to learn a new language.

In one exemplary embodiment, during a decision guidance to support an emergency response (ER) an officer may command a relief operation for a natural or man-made disaster. The ER officer is in charge of providing ER locations with items such as foods, water, blankets, medical supplies, etc. Assuming that the database is setup for this service has the following tables:

| | |
|---|---|
| demand(erloc, item, | a tuple indicating that for an ER location (erloc), |
| requested): | the quantity requested of item is needed. |
| supply(vendor, item, | a tuple indicates that a vendor can provide |
| price per unit, | at most available quantity of item at the |
| available): | price per unit. |
| orders(vendor, item, | a tuple indicates the order of item in |
| erloc, quantity): | quantity quantity from vendor for |
| location | erloc. |

In one embodiment with the above tables, a reporting system may have the following query to provide (total) cost information:

| | |
|---|---|
| CREATE VIEW total_cost AS | (5) |

```
  SELECT SUM(s.price_per_unit*o.quantity) AS total
  FROM orders o INNER JOIN supplier s
  ON o.vendor=s.vendor AND o.item=s.item;
```

In one embodiment, the item orders are decided elsewhere, and the database is simply to record these orders. The ER officer may need to decide these orders, with the objective of minimizing the cost. This is a typical “inverse” problem of the above reporting function. More specifically, the orders table needs to be filled such that all the demands are satisfied while the total_cost is minimized. This is a non-trivial problem especially when there are constraints such as limiting the number of vendors to supply a particular location (for the purpose of, e.g., limiting the possible vendor contact points to ease the management and tracking).

Typically, the state-of-art solutions will need to model the situation in a separate decision optimization system to make the order decisions. However, in one embodiment, the SQL query (5), plus some auxiliary SQL statements and SQL-like annotations (e.g., for adding the constraints), automatically generate mathematical programming models that will generate the optimal orders. The resulting annotated SQL query is a DGQL query.

In one embodiment, using the DGQL can leverage existing investment in database design through annotation which is a distinct advantage over modeling languages such as, for example, AMPL, GAMS, OPL, etc., because it allows a clear separation between modeling the business objects and processes, and indicating which parameters are to be used for decision making.

In one embodiment, a multistage decision optimization system is used, wherein the output of one decision problem is used as the input to another. By allowing for heavy query reuse, new optimization problems can be created by a few annotations with little advanced planning. Furthermore, additional information may be added to the system at different times, such as shipping options, packaging options, etc. For example, as multiple shipping companies may be available with different pricing structure, it is useful to optimize the total shipping cost with the best shipping option. In this example, additional tables as, shipping-options and shipping-orders may be considered. Furthermore, an additional query can be added to provide total shipping cost. The item orders and shipping orders are kept consistent, for example by using integrity constraints in the database.

It is noted that relational database systems allow modularized development, which increases the productivity of the programmers and makes the system development more intuitive. In the exemplary embodiment, with the additional needed information, the ER officer can also make shipping (and other) decisions so that the total_cost of items and shipping is minimized.

In other embodiments, other requirements may also be considered such as, for example, the time of delivery requirements. Similarly, the reporting function can be “inverted” to make decision optimizations, by reusing the SQL code already developed. If shipping option is added to the item orders, two tables, namely item orders and shipping orders can be filled to make the total_cost optimal. The DGQL query will be modular in the same way that SQL is.

In one embodiment, if orders table, as previously defined, is going to be filled with the objective of minimizing the total_cost as described by the total_cost query (5). In this embodiment, the orders table can be replaced with a view created by the following SQL statement plus an augment annotation:

| | |
|---|---|
| CREATE VIEW orders AS AUGMENT | (6) |

```
  (SELECT d.erloc, s.vendor, s.item
  FROM demand d
  LEFT OUTER JOIN supplier s
  ON d.item=s.item)
WITH quantity INTEGER >=0;
```

It is noted that the nested query (5) is a standard query, giving all possible parings of vendor with item for each emergency location, while the view (6) is a DGQL annotation that indicates the resulting table of the nested query to be augmented with an extra column called quantity with the condition that the quantity has to be a non-negative integer. The augmented column is the one to be filled by DGQL execution automatically with optimal objective.

In one embodiment, with any assignment of nonnegative values to the augmented quantity column of the generated orders table, there is a total_cost value given by the total_cost view (5). In this embodiment, an assignment is automatically generated that gives the minimum total_cost for the emergency example. However, it is noted that in the total_cost view (5), the table demand is not used. At the time when the reporting query is written, it is assumed that the orders table is given externally and that all the demands are satisfied by the orders. This assumption can be checked by the database with following constraint:

| | |
|---|---|
| CREATE VIEW requested_vs_delivered AS | (7) |
| SELECT o.erloc, o.item, | |
| SUM(o.quantity) AS delivered, d.requested | |
| FROM orders o | |
| INNER JOIN demand d | |
| ON o.erloc=d.erloc AND o.item=d.item | |
| GROUP BY o.erloc, o.item, d.requested | |
| CHECK delivered>=requested; | |

The constraint (7) checks whether an item request is satisfied at an emergency location with enough orders by comparing the total quantities of an item ordered for the location with the demand quantity at that location. This constraint needs to be explicitly given in order to generate orders table correctly, and DGQL supports the above constraint specification (while implementation of such a constraint in standard DBMS is not uniformly present).

Finally, the objective is specified explicitly. In DGQL, the following statement is utilized: MINIMIZE total_cost;

It is noted that total_cost is the view defined in query (1). The semantics of the MINIMIZE is to create a table for orders (in general, all augmented tables are instantiated), in which the last column is filled with integer values, in the way such that the total_cost is minimum among all possible orders to satisfy all the emergency demands.

The above optimization problem of minimizing the cost can be solved rather easily since the optimal strategy is to always to use the least-costly supplier for each item. This strategy can be coded directly in SQL and provide optimal solution without using DGQL or MP (although the code will look differently from the reporting query, increasing the management complexity). However, in general the capability of SQL in providing decision optimization is limited. For example, consider the situation that (1) each vendor has a limited supply of each item, and (2) in embodiments, it may be desirable to limit the number of (say up to 3) vendors to supply all the items for a particular emergency location in order to facilitate easier tracking and management. In this case, is not clear how to use SQL to directly code an optimal solution. In DGQL framework, this can be done with the following two additional constraints:

| | |
|---|---|
| CREATE VIEW purchased_vs_available AS | (8) |
| SELECT o.vendor, o.item, SUM(o.quantity) AS purchased, | |
| s.available | |
| FROM orders o | |
| INNER JOIN supplier s | |
| ON o.vendor=s.vendor AND o.item=s.item | |
| GROUP BY o.vendor,o.item,s.available | |
| CHECK purchased<=available; | |
| CREATE VIEW vendor_restriction AS | (9) |
| SELECT erloc, COUNT(*) AS vendors | |
| FROM (SELECT DISTINCT erloc, vendor | |
| FROM orders o | |
| WHERE quantity>0) | |
| GROUP BY erloc | |
| CHECK vendors<=3; | |

The constraint (8) above states that the ordered item quantity from a vendor does not exceed its available quantity and constraint (9) enforces that the total number of distinct vendors for each emergency location does not exceed 3. With the above constraints, DGQL will find the optimal solution satisfying these constraints.

It is noted that a constraint is quite different from a selection (WHERE) condition. Indeed, in examples, constraints will limit the possible orders table instantiations to be considered in obtaining the optimal solution by rejecting those that do not satisfy the constraints.

In addition, DGQL allows modular development. If shipping and other options are to be considered, so embodiments may only require annotation of the relevant queries and addition of appropriate constraints in order to extend the decision optimization problem. DGQL also takes the relevant existing SQL queries without any change in participating in decision optimization, reusing existing investment.

A precise exposition of the DGQL syntax and Semantics is now given. The philosophy of DGQL is the add annotation, in the form of operators, to the standard SQL in order to express decision optimization problems. Like the standard SQL, the precise syntax and semantics is best explained in the relational algebra. Hence, the approach of adding a number of operators to the standard relational algebra. The informal, SQL-like expressions directly correspond to these operators.

Similar to the standard relational algebra, given a set of base relations in a database, each having a unique name and schema. Assuming there is a supply of globally unique relation names to be used for assignments, each with a schema. Considering the conventional notions and notation, including those of schemas, domains, tuples, relations, databases and all the traditional algebraic operations, as well as the assignment statement (or view definition). In addition, utilization of a simple form of aggregation can be implemented.

The annotation of DGQL consists of three operations: augmentation, constraint, and optimization. All three operators are used in the example previously presented. Honoring the tradition, except for the optimization operator, which is the last statement in any DGQL program, augmentation and constraint are defined as relational operators that can appear at any step of a relational expression.

For ease of reference, the following is an example list of operators that can be used in DGQL. More precisely, DGQL query expressions are defined recursively as follows:

1) (Base case) Each relation name (base relation or not) is a DGQL query expression; The schema of the expression is exactly the relation schema of the base relation;
2) (Traditional operators) Given DGQL query expressions e₁ and e₂, then π_{L}(e₁), σ_{C}(e₁), e₁×e₂, e₁∪e₂, e₁∩e₂, and e₁−e₂ are all DGQL query expressions; The operations are all the traditional relational operators, and assuming the schema requirement of the operators are satisfied by e₁ and e₂; The schemas of the expressions are as defined traditionally;
3) (Arithmetic) Given DGQL query expression e, then γ[B=arith(L)](e), where L is a subset of numeric attributes in e, B is a new attribute, and arith(L) is an arithmetic expression using attributes in L.
4) (Aggregation) Given DGQL query expression e and assuming A₁, . . . , Aₙ and B are attributes of the schema of e, then δ[A₁, . . . , Aₙ, ƒ(B)](e) is a DGQL query expression, where ƒ is an aggregation function (mapping bags to values); The schema of the expression is A₁, . . . , Aₙ, ƒ(B); A special case is when n=0, in which only ƒ(B) attribute exists for the schema of the expression.
5) (Augmentation from Relation) Given DGQL query expressions e₁ and e₂ and assuming A₁, . . . , Aₙ are attributes in e1 and not attributes in e₂, α[A₁, . . . , Aₙεe₁](e₂) is also a DGQL query expression; The schema of the expression is the schema of e₂ extended with A₁, . . . , Aₙ;
6) (Augmentation from Domain) Given DGQL query expression e, α[Aεdomain](e) is also a DGQL expression, where domain is a set of values of a specific type, e.g., real[0,∞) for non-negative reals. This form of augmentation is equivalent to the above one if domain is taken as a (possibly infinite) relation with one attribute A and each value is taken as a tuple;
7) (Constraint) Given DGQL query expression e, then ξ[C](e) is a DGQL query expressions, where C a condition as found in selection. The schema of the expression is that of e;
8) (Optimization) Given a DGQL query expression e that computes a 1-tuple relation over a schema with a single attribute, ω[min/max](e) is also a DGQL query expression. The schema of the expression is that of e.

Definition 1 A DGQL query is an assignment sequence of the form

R₁=e₁; . . . ;Rₙ=eₙ;ω

where each eᵢ is a DGQL expression and ω is either min(Rₖ) or max(Rₖ), where 1≦k≦n and eₖ must compute a single numeric value, or sat. That is, a DGQL query is a sequence of assignments followed by an optimization operator or a satisfiability operator.

A valid DGQL query is one that always uses a relation name that is either a base relation name, or one that has been defined (i.e., on the left-hand-side of an assignment) earlier the sequence. Assuming that valid DGQL expressions are utilized, if validity is not mentioned.

The example in queries (6)-(9) can be easily rewritten in the DGQL algebraic query form, with each view being an assignment followed by MINIMIZE total_cost or ω=min(total_cost).

Turning to the definition of the semantics of DGQL queries. For simplicity, it can be assumed that in a DGQL query, each e₁ either a single relation name (base relation name or one of (R₁, . . . , Rᵢ₋₁) or a single operator applied to operands in the form of single relation names, and en must be one of Ri. In other words, each assignment is a “simple step” of copying a relation or applying one operation over the previously defined relations. Assuming the optimization operator only applies to single relation name, e.g., ω(Rₖ) where 1≦k≦n.

Definition 2 A DGQL query is a basic assignment sequence if each assignment is a simple step as described above.

Since a DGQL query can be rewritten into a basic assignment sequence by introducing more assignments, without loss of generality, assuming all DGQL queries are basic assignment sequences if not mentioned otherwise.

Intuitively, (a) the assignments of a DGQL query is to gives all “feasible” instantiations of all the relations for the left-hand-side of each assignment such that the “input” and “output” of each assignment is “correct”, i.e., given the input relations, the left-hand-side relation is actually the result of the operator applied to the given operands; (b) the optimization operator as the last step of a DQQL query is to find one such feasible instantiation such that the en value is the minimum or maximum (depending on either min or max is used in the last step) among all the feasible instantiations. For example, the DGQL query for cost minimization obtains an assignment to all the views, including the view orders such that the total_cost is minimized. In this way, the optimization done by DGQL automatically fills the orders table for the emergency response application.

Different from the standard SQL, where the operands and the operator determine the output relation, the DGQL operator augmentation introduces non-determinism. That is, for the augmentation operator, infinitely many “output” relations may correspond to an “input” relation. Therefore, a DGQL query can have many feasible instantiations for the assignment sequence. And the optimization operator in the end is to choose one feasible instantiation.

Formally, consider a DGQL query R₁=e₁; . . . ; Rₙ=eₙ; ω. A (non-deterministic) execution path is a sequence (r₁, . . . , rₙ) of relations over the schemas of e₁, . . . , eₙ, respectively. A partial execution path is a prefix of an execution path, i.e., a sequence of relations (r₁, . . . , rᵢ), 1≦i≦n, of relations over the schemas of e₁, . . . , eᵢ respectively, or the empty prefix ε.

Definition 3 The feasibility of a partial execution path is defined recursively as follows. The empty execution path ε is feasible. Recursively, (r₁, . . . , rᵢ), 1≦i≦n, is feasible if (a) (r₁, . . . , rᵢ₋₁) is feasible, and (b) the following is satisfied:
if eᵢ is a traditional or aggregation operation, then rᵢ is the result of eᵢ computation when operands from R₁, . . . , Rᵢ₋₁ are replaced with relations r₁, . . . , rᵢ₋₁ respectively;
if eᵢ is an augmentation operation α[A₁, . . . , AₘεRⱼ](Rₖ), where 1≦k, j<i, rᵢ has the schema of Rₖ extended with A₁, . . . , Aₘ, and is constructed by joining a tuple from rₖ with a single tuple (non-deterministically chosen) from π_{A}_{₁}_{, . . . , A}_{ₘ}(rⱼ). Similarly, if eᵢ is α[Aεdomain](Rₖ), where 1≦j<i, rᵢ has the schemas of Rₖ extended with A, and is constructed by joining a tuple from rₖ with a single value (non-deterministically chosen) from the domain of A.
if eᵢ is a constraint operation ξ[C](Rⱼ), 1≦j<i, the constraint C is satisfied by rⱼ and rᵢ=rⱼ.
   Considering (r₁, . . . , rₙ) is a feasible execution path if it is a feasible partial execution path and denote by F(d) the set of all feasible execution paths for R₁=e₁; . . . ; Rₙ=eₙ and input database d

Definition 4 The semantics of a DGQL query

R₁=e₁; . . . ;Rₙ=eₙ; ω

is defined as the function

Φ:D1→2^{D2},

where D₁ is the set of all relational databases over the base database schemas, and D₂ is the set of all databases over the schema S₁, . . . , Sₙ of the expressions e₁, . . . , eₙ, respectively, as follows. For a given database d, Φ(d) is the set of all databases d′=(r₁, . . . , rₙ) such that it gives the optimal value among all the feasible execution paths, e.g.,
Case 1: When ω=sat, Φ(d) is the set of all feasible execution paths, i.e., Φ(d) def F(d)
Case 2: When ω=min(Rₖ), Φ(d) is the set of all feasible execution paths that give the minimum value computed by rₖ among all feasible execution paths, i.e., Φ(d) def {(r₁, . . . , rₙ)ε(d)|∀(r′₁, . . . , r′ₙ)εF(d), rₖ≦r′ₖ}
Case 3: When ω=max(Rₖ), Φ(d) is the set of all feasible execution paths that give the maximum value computed by rₖ among all feasible execution paths, i.e., Φ(d) def {(r₁, . . . rₙ)εF(d)|∀(r′₁, . . . , r′ₙ)εF(d), rₖ≧r′ₖ}

Note that the optimal value may not lead to a unique feasible execution path, i.e., more than one assignment to relations r₁, . . . , rₙ may lead to the same optimal value for rₖ. A database d′=(r₁, . . . , rₙ)εΦ(d) is a non-deterministic answer to the DGQL query. If Φ(d)=Ø, ⊥ (which denotes infeasibility) is returned and assigned to R₁, . . . , Rₙ.

A mathematical programming (MP) problem has the form min ƒ(\hat{x}) s.t. C(\hat{x}) where \hat{x} is a vector of variables that range over domain \hat{D}, ƒ is an objective function from \hat{D} to the set of reals [symbol] , and C(\hat{x}) is a constraint. The constraint C(\hat{x}) is associated with a Boolean function that, given an instantiation of vector âε\hat{D} to \hat{x}, evaluates to True or False. A solution to the optimization problem is a vector âε\hat{D} that satisfies the constraint C so that ƒ(â)≦ƒ(\hat{b}) for all vectors \hat{b} that satisfy C. Note that min can be replaced with max in this formulation without difficulties

Formal optimization models are solved using MP algorithms. MP algorithms heavily depend on the type of the problem, determined by the domains of the variables (e.g., reals, integers, binary, finite domain), the structure of constraints C (e.g., linear, quadratic, polynomial, etc.), and the form of the objective function f. As an example, Linear Programming (LP) is a class of MP where variables range over reals, constraints are inequalities between linear arithmetic expressions, and the objective function is linear.

The LP problem was proven to be in P. However, the class of SIMPLEX algorithms is still the most widely used in practice, although its worst case complexity is exponential in the dimension (i.e., the number of variables). On the other hand, even the {0, 1} Integer Linear Programming (ILP), is known to be NP-complete. The Branch and Bound algorithm is a popular algorithm for ILP and MILP (mixed integer LP). While exponential in the worst case, it has the nice property of reaching intermediate (not necessarily optimal) solutions. MILP is utilized to encode DGQL queries and derive solutions.

The key idea of the reduction procedure is to use a symbolic table formation to represent each step of a DGQL query. For this purpose, assuming that every tuple in a relation has a globally unique tuple identifier tid, when new tuples are generated, new tids will be generated correspondingly.

Definition 5 A symbolic table is a standard relational table with the following additions: (a) an attribute can be of a constraint variable name type (or CVN type), and the domain of a CVN attribute is variable names, (b) there must be a special attribute of CVN type named TAF, for tuple-active-flag, with domain of binary variable names of the form taf[tid], where tid is the tuple id of the tuple.

As an example, table 2 is a symbolic orders table:

TABLE 2

| TAF | sup | item | erloc | qty |
|---|---|---|---|---|
| taf[1] | s1 | i1 | l1 | qty[1] |
| taf[2] | s2 | i2 | l2 | qty[2] |

where TAF and qty are CVN type attributes. The idea of TAF attribute is to indicate if the particular tuple exists in the table in a feasible execution path, and the CVN attributes allow possible instantiations.

Symbolic tables are to be instantiated as regular relational tables by instantiation of variables. More specifically, given an instantiation of variables appearing in a symbolic table, the symbolic table becomes a regular table, minus the TAF column as follows: For each tuple t in the symbolic table, if taf[id] is instantiated to 1, then the resulting regular table contains the tuple t with other CVN attributes instantiated and TAF attribute dropped. For example, in the above table 2, if taf[1]=1, taf[2]=0, qty[1]=20, and qty[2]=4, then the resulting table is Table 3:

TABLE 3

| sup | item | erloc | qty |
|---|---|---|---|
| s1 | i1 | l1 | 20 |

It is noted that, the TAF attribute is dropped. The reduction to MILP is as follows: given a DGQL query R₁=e₁; . . . ; Rₙ=eₙ; ω, a symbolic table for each Rᵢ can be generated. But in order to represent all the feasible execution paths, constraints are to be added so all and only feasible execution paths are represented. In other words, the reduction result will be a triple

({s₁, . . . ,sₙ},V,C)

where {s₁, . . . , sₙ} are symbolic relational tables, V is the set of all constraint variables, including those that appear in {s1, . . . , sn}, and C is a set of constraints over V. The schema of each sᵢ, 1≦i≦n, will be the schema of e_{z} extended with the TAF attribute.

Definition 6 Given the reduction result ({s₁, . . . , sₙ}, V, C) and an instantiation of variables in V to values in their corresponding domains, it can be stated that (r₁, . . . , rₙ) is a reduction instantiation of ({s₁, . . . , sₙ}, V, C) if ∀ i such that 1≦i≦n, rᵢ is constructed by (a) replacing variables in sᵢ with their corresponding instantiated values, (b) eliminating all tuples in sᵢ where TAF attribute is False, and (c) removing the TAF attribute.

As a precursor to the procedure of obtaining a reduction from a DGQL query, formalization of the correctness of the reduction result is considered. As discussed above, the symbolic tables together with the constraints should represent all and only feasible execution paths. To formalize this idea, the following is considered:

Definition 7 The reduction result ({s₁, . . . , sₙ}, V, C) of a DGQL query R₁=e₁; . . . ; Rₙ=eₙ; ω is said to be correct if:

### Soundness

Every reduction instantiation (r₁, . . . , rₙ) of (s₁, . . . , sₙ) that satisfies constraint C is indeed a feasible execution path of the DGQL query; and

### Completeness

Every feasible execution path is a reduction instantiation of (s₁, . . . , sₙ) that satisfies C.

The reduction steps follow the traditional relational algebra approach in the sense that each step generates a new symbolic table and add appropriate constraints. These steps are summarized in Algorithm 1.

Algorithm 1 produces symbolic tables sᵢ recursively using the symbolic tables generated earlier. The base case (steps 2-5) is to make the base database tables symbolic by adding a TAF attribute and the corresponding variables and constraints, indicating that all the tuples are “active” in the base tables. At each step of the reduction (steps 7-10), a new symbolic table for e₁ is generated and constraints and variables added to C and V, respectively.

Algorithm 1 Constraint Reduction

```
Inₚut: A DGQL query R₁ = e₁; ...; Rₙ = eₙ; ω
Output: A correct reduction ({s₁, ..., sₙ}, V, C)
Method:
1: Let V = Ø and C = True
2: for each base table B do
3: generate a symbolic table by adding a TAF attribute
4: for each tuple in B with tuple id tid, use CVN taf[tid] as the value
      under TAF, and let C = C [symbol]  taf[tid]. Add taf[tid] to V.
5: end for
6: for i = 1 to n − 1 do
7: Generate symbolic table sᵢ from the operator of eᵢ and the input
      symbolic tables used in eᵢ (these input symbolic tables must be
      from s₁ , ..., sᵢ₋₁ and those corresponding to the base tables).
8: Generate the corresponding Cᵢ
9: Add the new variables used in sᵢ and Cᵢ to V
10:  Let C = C [symbol]  Cᵢ
11:  end for
12:  return ({s₁, ..., sₙ}, V, C)
```

Step 7 of Algorithm 1 is to generate a symbolic table for sᵢ given one or two symbolic tables as the input. The schema of the output table is easily found by using the formal definition of the DGQL and traditional relational algebra operators. Setting up all the tuples in s₁ is easy for most operators, but a bit challenging for others. Intuitively, the possible output tuples in s₁ and use constraints involving taf[tid] can be set up to indicate if the tuple should actually exist in a feasible execution path. For example, if the operator is the selection operation, then the output table can be simply a copy of the input table, but in the constraint, an output tuple exists only if the selection condition is true. Use of a constraint instead of simply dropping the tuple provides that the selection condition may be applied to a CVN entry whose value is unknown at the reduction time.

The number of all possible tuples in sᵢ can be exponential in some cases. For example, when “group by” is done on a CVN attribute, sᵢ is set up to prepare for all possible groupings since the values of these CVN attributes are not yet known. In embodiments, it may be desirable to restrict “group by” only on non-CVN attributes so that the grouping will be known at the reduction time and each group will correspond to one possible tuple in s₁ (although the actual values in the tuple may remain CVN and unknown at the reduction time).

Once the symbolic output table is setup, the remaining task is to generate the constraint (Step 8). This step is basically to encode the correspondence between the input tuples and the possible output tuples. Since it is which symbolic tuple in the output is generated by which input tuples, this task is relatively easy as this is in reality a tuple level task. Next, the correctness of the reduction can be addressed.

Theorem 1 The reduction produced by Algorithm 1 is correct, i.e., both sound and complete.

Using the correct reduction, the result of a DGQL query can be derived as indicated in Algorithm 2. Basically, the corresponding MP problem given by the correct reduction result is solved (Step 1). If the constraint is infeasible, then return ⊥ (Steps 2-3). Otherwise, use the instantiation of the variables found in the CSP solution (Step 6) or MP solution (Step 8) to instantiate all the symbolic tables (Step 10).

Theorem 2 Algorithm 2 correctly, by Definition 4, computes the DGQL query result.

The running times of mathematical programs are often sensitive to the way the problem is represented. For many classes of problems, a poor choice of mathematical representation will cause the solver to take significantly longer to find an optimal solution. One concern with DGQL is that the extra views and tables used in modeling add substantial overhead by introducing redundant or unnecessary variables and constraints. A simpler or more concise modeling may lead to a significantly faster solution.

Algorithm 2 DGQL Computation

```
Input: A DGQL query R₁ = e₁; ...; Rₙ = eₙ; ω and a database d
Output: Query result
Method:
1. Perform Constraint Reduction (Algorithm 1) to produce ({s₁, ..., sₙ},
    V, C)
2. if constraint C is infeasible then
3. return ⊥
4. else
5. if ω = sat then
6. Solve the CSP for C and V
7. else
8. Solve the MP problem min/max V_{R}_{ₖ} such that C is satisfied
9. end if
10.  Given the variable instantiation produced in Step 6 or Step 8, return
      the Reduction Instantiation (r₁, ..., rₙ) as described in Definition 6.
11. end if
```

The hypothesis is that problems described using DGQL are solved as efficiently as when described using algebraic modeling languages such as AMPL or GAMS. As an initial step to test this hypothesis, consider the logistics optimization problem previously discussed and manually created a concise AMPL formulation of the same problem. Then generation of several database instances varying problem size and compared the running time when solved using this AMPL model and through DGQL reduction. The AMPL implementation can be found below.

```
set Vendors;
set Items;
set Locations;
param PricePerUnit{Vendors,Items}>=0;
param Available {Vendors, Items}>=0;
param Requested {Locations, Items}>=0;
var Orders {Vendors, Items, Locations}>=0;
var OrderPlaced{Vendors, Items, Locations} binary;
var ItemsPurchased{Vendors, Locations}>=0;
var VendorShipped{Vendors, Locations} binary;
minimize total_cost:
  sum{v in Vendors} sum{i in Items} sum{l in Locations}
    PricePerUnit [v,i] *Orders [v,i,l];
subject to
available_vs_purchased {v in Vendors, i in Items};
  Available [v,i] >= sum{l in Locations} Orders [v,i,l];
requested_vs_delivered {l in Locations, i in Items};
  Requested [l,i] <= sum{v in Vendors} Orders [v,i,l];
order_placed {v in Vendors, i in Items, l in Locations};
  OrderPlaced [v,i,l] = 0 ==>
    Orders [v,i,l] = 0 else Orders [v,i,l] >= 1;
items_purchased {v in Vendors, l in Locations}:
  ItemsPurchased [v,1] =sum{i in Items} OrderPlaced [v,i,1];
vendor_shipped {v in Vendors, l in Locations};
  VendorShipped [v,1] = 0 ==>
    ItemsPurchased [v,1] =0 else ItemsPurchased [v,l] >=1;
vendor_restriction {l in Locations}:
  sum {v in Vendors} VendorShipped [v,l] <= 3;
```

The DGQL query and the AMPL program were run using ILOG CPLEX as the solver. The test was on Windows XP running on a 2.0 GHz Core 2 Duo with 4 GB of RAM. In both cases, the tuning parameters passed to ILOG CPLEX were the same and were typical for solving MILP problems.

The size of the ER problem here is parameterized by the number of vendors, items, and ER locations. Given these parameters, a problem is generated by randomly instantiating the database tables supply and demand Note that problem size corresponds to the number of decision variables in orders as well as the indicator variables (tuple-active-flags) implicit in vendor restrictions. Thus, compute this directly from the problem parameters, i.e., decision variables=vendors*items*locs and indicator variables=vendors*items*locs+vendors*locs.

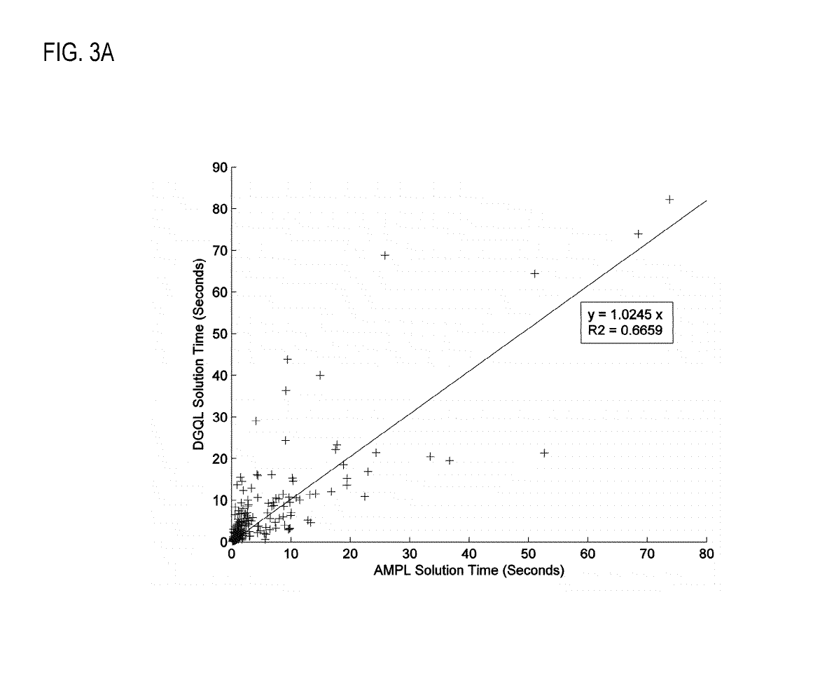

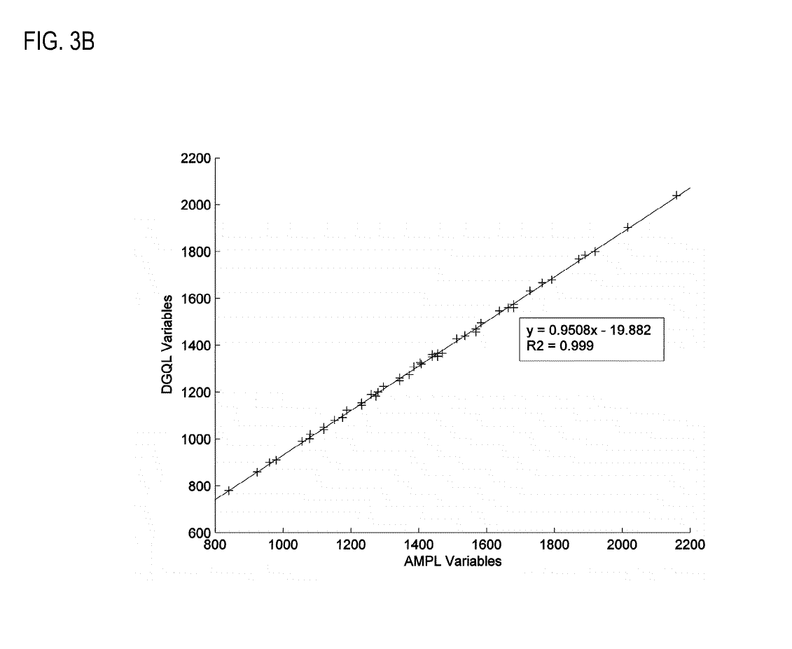

Each random problem generated was solved using both the DGQL reduction and the AMPL program, and the solution time was measured. This is the CPU time spent searching for an optimal solution and does not include the time to load the program off disk, or in the case of DGQL from the database. Only random databases that contained a feasible solution were included in the results. The solution time for both the DGQL and AMPL implementations was less than 10 ms for every randomly generated infeasible problem. The results of this experiment can be seen in FIG. 3A.

Note in the graph, a linear regression through the origin has slope 1.0245. This would imply that the AMPL model is on average ≈2.45% faster than DGQL. This difference is small and not significant when considering the large variation in solution time between the two systems for the same problem.

Further, and upon closer inspection, it appears the any implied advantage AMPL has is limited only to those problem instances where a tight solution is found by CPLEX quickly. In contrast, DGQL implementation can use Java and JNI to communicate with CPLEX and this may add overhead to small problems. Moreover AMPL performs limited pre-solving when converting problems into a special format CPLEX understands which may reduce CPLEX solution time.

Additionally, DGQL has better performance on problem instances where a larger parameter space must be searched. This is due in part to the fact that the AMPL formulation has an extra vendors*erlocs number of variables in its solution space (see FIG. 3B). As the ER problems become larger, this extra number of variables will have a measurable impact on solution time.

In constraint encoding of the step Rᵢ=eᵢ of a DGQL sequence R₁=e₁; . . . ; Rₙ=eₙ; ω depends on the algebraic operator in eᵢ. For an augment operator, an augmented attribute is replaced in each tuple with a CVN attribute that will hold a constraint variable name (unique per tuple id). For the constraint operator, the constraints C being built in the reduction with the corresponding constraints are extended over variables or constants in every tuple. For each of the deterministic operators, a symbolic representation of the result is constructed and the constraint that connects the variables in the output to the variables in the input is added. For the optimization operator, an optimization problem that minimizes or maximizes the variable value computed by the operand of the optimization operator id represented.

A simplified version of a reduction example can be used by considering just a single location, ignoring available quantities by suppliers, and combining the demand and supply tables in a single view supplier_selection_input as follows:

TABLE 4

| vendor | item | ppu | requested |
|---|---|---|---|
| S1 | I1 | 2.5 | 100 |
| S1 | I2 | 10 | 20 |
| S2 | I1 | 3.1 | 100 |
| S2 | I2 | 9 | 20 |

In table 4, the attribute ppu is the price per unit charged by the vendor, and requested is the total quantity of the item that is requested from all vendors. For each vendor and item, the quantity of the item to be purchased from that vendor is found so that the total purchase cost is minimal while the demand is satisfied. In SQL-like form, below is a DGQL program to do that:

```
CREATE VIEW orders AS AUGMENT
  supplier_selection_input
WITH qty INTEGER >= 0;
CREATE VIEW total_cost AS
  SELECT SUM(o.ppu * o.qty) AS total
  FROM orders o;
CREATE VIEW requested_vs_delivered AS
  SELECT o.item, o.requested, SUM(o.qty) AS delivered
  FROM orders o
  CHECK delivered >= requested;
MINIMIZE total_cost;
```

An algebraic form of this program is given below. The first view definition (with augment and inequality) is expressed as:

R₁ = supplier_selection_input
R₂ = α[qty ∈ INTEGERS](R1)
R₃ = ξ[qty ≧ 0](R₂)

The second view total_cost is expressed as:

R₄ = γ[cost = ppu * qty](R₂)
R₅ = δ[total = sum(cost)](R₄)

The third view requested_vs_delivered and the CHECK constraint are expressed as:

R₆ = δ[item, requested, delivered = sum(qty)](R₂)
R₇ = ξ[delivered ≧ requested](R₆)

Finally, the minimization statement is expressed as:

ω=min(R₅)

It is shown here, how a reduction to mathematical programming is done step by step. Initially S₀=Ø, i.e., no tables for R₁, . . . , Rₙ have been constructed, V₀=Ø, and C₀=True. After the first assignment into R₁, S₁={s₁}, where s₁ is the input table extended with the attribute TAF with values being binary constraint variables:

TABLE 5

| tid | TAF | vendor | item | ppu | requested |
|---|---|---|---|---|---|
| tid1 | taf[tid1] | S1 | I1 | 2.5 | 100 |
| tid2 | taf[tid2] | S1 | I2 | 10 | 20 |
| tid3 | taf[tid3] | S2 | I1 | 3.1 | 100 |
| tid4 | taf[tid4] | S2 | I2 | 9 | 20 |

It is noted that, tid1, tid2, tid3, tid4 are unique tuple identifiers. Adding new variables for the TAF attribute and the constraints to indicate that they must be True, i.e., V₁=taf[tid1], . . . , taf[tid4] and C₁=taf[tid1] [symbol] . . . [symbol] taf[tid4].

After the second assignment into R₂, the table s₂ will be as seen in Table 6:

TABLE 6

| tid | TAF | vendor | item | ppu | requested | qty |
|---|---|---|---|---|---|---|
| tid5 | taf[tid5] | S1 | I1 | 2.5 | 100 | qty[tid5] |
| tid6 | taf[tid6] | S1 | I2 | 10 | 20 | qty[tid6] |
| tid7 | taf[tid7] | S2 | I1 | 3.1 | 100 | qty[tid7] |
| tid8 | taf[tid8] | S2 | I2 | 9 | 20 | qty[tid8] |

It is noted that values for attribute qty are constraint variables qty[tid5], . . . , qty[tid8] which will need to be instantiated by the system. The variable set V₂ will be V₁∪{taf[tid5], . . . , taf[tid8], qty[tid5], . . . , qty[tid8]}. The constraints C₂ will be C₁ [symbol] taf[tid5]=taf[tid1] [symbol] . . . [symbol] taf[tid8]=taf[tid4] to indicate that all the tuples (with instantiated values to qty variables) must appear in the result.

Following the third assignment into R₃, the table and set of variables do not change, i.e., s₃=s₂ and V₃=V₂, and the set of constraints is extended to indicate that the qty variables are greater than or equal to zero. That is C₃=C₂ [symbol] qty[tid5]≧0 [symbol] . . . [symbol] qty[tid8]≧0.

Following assignment to R₄, the table for s₄ will be as seen in Table 7:

TABLE 7

| | | | | | request- | | |
|---|---|---|---|---|---|---|---|
| tid | TAF | vendor | item | ppu | ed | qty | cost |
| tid9 | taf[tid9] | S1 | I1 | 2.5 | 100 | qty[tid5] | cost[tid9] |
| tid10 | taf[tid10] | S1 | I2 | 10 | 20 | qty[tid6] | cost[tid10] |
| tid11 | taf[tid11] | S2 | I1 | 3.1 | 100 | qty[tid7] | cost[tid11] |
| tid12 | taf[tid12] | S2 | I2 | 9 | 20 | qty[tid8] | cost[tid12] |

The set of variables will be extended with the new cost variables, and the constraints will be extended to indicate how the cost is computed, i.e., V₄=V₃∪{taf[tid9], . . . , taf[tid12], cost[tid9], . . . , cost[tid12]} and C₄=C₃ [symbol] cost[tid9]=2.5*qty[tid5] [symbol] . . . [symbol] cost[tid12]=9*qty[tid8].

Following fifth assignment into R₅ the table s₅ will be as seen in Table 8:

TABLE 8

| tid | TAF | Total |
|---|---|---|
| tid13 | taf[tid13] | total[tid13] |

The only new variable is total[tid13] and the new constraint states that the total_cost is the summation of costs. It is noted that the constraint

total[tid13]=cost[tid9]+ . . . +cost[tid12]

is not sufficient since tuples in s₄ may or may not appear in the final table instantiation. Instead, new variables cost′[tid9], . . . , cost′[tid13] are introduced and utilized, and for each tuple it is expressed that the new cost′ variable equals cost if its taf variable is True, and equals 0 otherwise. That is, V₅=V₄∪{total[tid13], cost′[tid9], . . . , cost′[tid13]} and

C₅=C₄ [symbol] total[tid13]=cost′[tid9]+ . . . +cost′[tid13]

[symbol]

taf[tid9]→cost′[tid9]=cost[tid9]

[symbol]

[symbol]

taf[tid9]→cost′[tid9]=0 [symbol] . . .

[symbol]

taf[tid13]→cost′[tid9]=cost[tid13]

[symbol]

[symbol]

taf[tid13]→cost′[tid13]=0

Following the sixth assignment into R₆ the symbolic table s₆ will be as seen in Table 9:

TABLE 9

| Tid | TAF | item | requested | delivered |
|---|---|---|---|---|
| tid14 | taf[tid14] | I1 | 100 | delivered[tid14] |
| tid15 | taf[tid15] | I2 | 20 | delivered[tid15] |

The set of variables is extended with the new taf and delivered (i.e., total items purchased) variables, and the new constraint will reflect how delivered are computed. Again, the computation of delivered for I1 cannot simply be expressed as:

delivered[tid14]=qty[tid5]+qty[tid7]

because tuples tidy and tid7 may or may not appear in the result instantiation. Instead, the idea is to introduce and use new variables, e.g., qty[tid5] and qty[tid7], and express that each of them is equal to the corresponding qty variable if the corresponding taf variable is True (which indicates that the tuple will be in the answer), and it is equal to 0 if the corresponding taf variable is False. Thus, V₆=V₅∪{taf[tid14], taf[tid15], qty′[tid5], . . . , qty′[tid8], delivered[tid14], delivered[tid15]} and

C₆=C₅ [symbol] delivered[tid14]=qty′[tid5]+ . . . +qty′[tid7]

[symbol]

delivered[tid15]=qty′[tid6]+ . . . +qty′[tid8]

[symbol]

taf[tid5]→qty′[tid5]=qty[tid5]

[symbol]

[symbol]

taf[tid5]→qty′[tid5]=0 [symbol] . . .

[symbol]

taf[tid8]→qty′[tid8]=qty[tid8]

[symbol]

[symbol]

taf[tid8]→qty′[tid8]=0

[symbol]

taf[tid14] [symbol] (taf[tid5] [symbol] taf[tid7])

[symbol]

taf[tid15] [symbol] (taf[tid6] [symbol] taf[tid8])

Following the seventh assignment into R₇ the symbolic table and the set of variables do not change, i.e., s₇=s₆ and V₇=V₆, but new constraints are added to each tuple, i.e., C₇ is a conjunction of C₆ and the new constraints:

delivered[tid14]≧100 [symbol] delivered[tid15]≧20

Finally, after the eighth assignment into R8, the system extracts the objective total[tid13], and solves the optimization problem:

min total[tid13] s.t. C₇

If the problem is feasible, the solution of the optimization problem gives an instantiation of a value into each variable in V₇. The output of the DGQL program is a database r1, . . . , r8, where each rᵢ is constructed from the symbolic table sᵢ as follows. First, each of the variables is replaced with the instantiated values. Second, each of the tuples in which the TAF variable is False is discarded. Finally, the special attribute TAF is removed.

In considering reduction formally, reduction is created iteratively, by constructing a triple Qᵢ=(Sᵢ={s₁, . . . , sᵢ}, Vᵢ, Cᵢ), for every i, 1≦i<n, which will be a reduction from the partial assignment sequence expression (R₁=e₁; . . . ; Rᵢ=eᵢ), as follows. Initially, S₀=Ø, V₀=Ø, and C₀=True. Iteratively, given Qᵢ₋₁, 1≦i<n−1, Qᵢ is constructed based on the query expression eᵢ as follows:
If eᵢ is a base relational name R, and r is the corresponding base relation, sᵢ will be constructed from r by adding the attribute TAF (whose value for a tuple will be the variable TAF[tid] where tid is that tuple id). Vᵢ will be the union of Vᵢ₋₁ and the set of new TAF[tid] variables. Cᵢ will be the conjunction of Cᵢ₋₁ and the equality constraint TAF[tid]=True for every tuple in r.
If eᵢ is a previously assigned relational name Rⱼ (1≦j<i), then Qᵢ is constructed by taking Vᵢ=Vᵢ₋₁, Cᵢ=Cᵢ₋₁ and sᵢ=sⱼ.
If eᵢ is an augmentation-from-domain α[AεD](Rⱼ), where 1≦j<i, then Qᵢ is constructed as follows. The relation sᵢ is constructed from sⱼ by adding a CVN(D) attribute, and using as its value the variable name A[tid] for every tuple in sⱼ. Vᵢ is the union of Vᵢ₋₁ with the set of all new variables in the CVN(D) attribute. Finally, Cᵢ=Cᵢ₋₁.
If eᵢ is an augmentation-from-relation α[A₁, . . . , AₘεRⱼ](Rₖ), where 1≦j, k≦n, then Qᵢ is constructed as follows. The relation sᵢ is constructed from sₖ, by adding attributes A₁, . . . , Aₙ of type CVN (over the corresponding domains in sⱼ). Vᵢ is the union of Vᵢ₋₁ and the set of all new variables. Finally, Cᵢ is the conjunction of Cᵢ₋₁ and the constraint

$${}_{tid ∈ Tid} ( TAF [ tid ] = True \to ( {A}_{1} [ tid ] , … , {A}_{m} [ tid ] ) ∈ {s}_{j} )$$

where Tid is the set of all tuple ids in sₖ.
If eᵢ is a projection operation π_{L}(Rⱼ), where 1≦j<i, then Qᵢ is constructed as follows. Vᵢ=Vᵢ₋₁, Cᵢ=Cᵢ₋₁, and sᵢ=π_{L′}(sⱼ), where L′=L∪{TAF}.
If eᵢ is a (bag) union operation Rⱼ∪Rₖ, where 1≦k, j<i, then Qᵢ is constructed by taking sᵢ=sⱼ∪sₖ, Vᵢ=Vᵢ₋₁ and Cᵢ=Cᵢ₋₁.
If eᵢ is an intersection operation Rⱼ∩Rₖ, where 1≦j, k<i, then Qᵢ is constructed as follows. Assume A₁, . . . , Aₗ, B₁, . . . , Bₘ is the schema of both Rⱼ and Rₖ, where A₁, . . . , Aₗ are all attributes that are non-CVN in both sⱼ and sₖ. For every pair of tuples tid₁εsⱼ and tid₂εsₖ that agree on A₁, . . . , Aₗ, construct a tuple tid (new id), with values for A₁, . . . , Aₗ taken from tid₁ (which are the same as in tid₂), and the values for CVN attributes B₁, . . . , Bₘ being variable names B₁[tid], . . . , Bₘ[tid], as well as CVN({0,1}) attribute TAF. sᵢ is constructed as the bag of all such tuples. Vᵢ will be the union of Vᵢ₋₁, the set of all new (globally unique) variables above, and the set of an auxiliary CVN({0,1}) variables E[tid] for every tid in sᵢ. To construct Cᵢ, create the following new constraint for every tuple tid in sᵢ:

E[tid]=True→(tid₁.B₁=tid₂.B₁ [symbol] . . . [symbol] tid₁.Bₘ=tid₂.Bₘ) [symbol] TAF[tid]=TAF[tid₁] [symbol] TAF[tid₂] [symbol] E[tid]

where tid₁, tid₂ are two tuples that gave rise to tuple tid in S. Note that values of the B attributes (such as tid₁.B₁) may either be drawn from the original domain of B (e.g., if B₁ is a non-CVN attribute in sⱼ), or a variable name (e.g., B₁[tid₁], if B₁ is a CVN attribute in sⱼ.) Finally, Cᵢ is constructed as the union of Cᵢ₋₁ and the set of all new constraints above.
If eᵢ is a set difference operation Rⱼ−Rₖ, where 1≦j, k<n, Qᵢ is constructed by taking sᵢ=sⱼ−sₖ, Vᵢ=Vᵢ₋₁, and Cᵢ=Cᵢ₋₁. Assuming that the set difference cannot involve augmented attributes.
If eᵢ is a Cartesian product Rⱼ×Rₖ, where 1≦j, k<i, then Qᵢ is constructed as follows. sᵢ is constructed by (1) computing sⱼ×sₖ, and (2) replacing two attributes Rⱼ.TAF and Rₖ.TAF with a single attribute TAF of type CVN({0,1}). Recall that each tuple in the Cartesian product will have a new global tid, and then the value of TAF for that tuple will be the variable TAF[tid]. Vᵢ is the union of and the set of all new TAF variables. Cᵢ is the conjunction of Cᵢ₋₁ and the constraints TAF[tid]=TAF[tid₁] [symbol] TAF[tid₂], for all tid in the Cartesian product, where tid₁ and tid₂ are the ids of tuples from sⱼ and sₖ, respectively, that formed the tuple tid.
If eᵢ is selection operation σ_{P}(Rⱼ), where 1≦j<i and P is the selection predicate then Qᵢ is constructed as follows. Let P=P_{reg} [symbol] Pₑᵥₙ, where P_{reg} is the selection predicate that does not involve CVN attributes, and Pₑᵥₙ is the selection predicate that may involve CVN attributes. sᵢ is constructed as σ_{P}_{_{reg}}(sⱼ). Note that sᵢ has globally new tuple ids, and thus the variables TAF[tid] in tuples of s₁ are new unique variables. For every new variable TAF[tid] there is a creation of an auxiliary binary variable PB[tid]. Vᵢ is constructed as the union of Vᵢ₋₁ and the set of all new variables TAF[tid] and PB[tid] for every tid in s′ⱼ. Finally, Cᵢ is the conjunction of Cᵢ₋₁ and

$${}_{tid ∈ Tid} ( PB [ tid ] = True ↔ {PP}_{cvn} [ tid ] TAF [ tid ] = PB [ tid ] TAF [ {tid}^{′} ] )$$

where Tid is the set of all tuple ids in sᵢ, tid′ is the id of the tuple in sⱼ from which the tuple tid in sᵢ originated in selection, and PPₑᵥₙ[tid] is the constraint constructed from Pₑᵥₙ by replacing every attribute name A with CVN variable A[tid].
If eᵢ is an aggregation δ[A₁, . . . , Aₙ, ƒ(B)](Rⱼ), 1≦j<i, then Qᵢ is constructed as follows. sᵢ is constructed from π[A₁, . . . , Aₙ](sⱼ) (with all new tuple ids), by first eliminating duplicates, and then adding the CVN(D) attribute ƒ(B), where D is the domain of values returned by aggregation ƒ, and CVN({0,1}) attribute TAF. Vᵢ is the union of Vᵢ₋₁ and all new variables ƒ(B)[tid], TAF[tid], for each tid in Sᵢ, and also auxiliary variables B′[tid] for every tid in sⱼ. Cᵢ will be the conjunction of Cᵢ₋₁ with

$${}_{tid ∈ Tid} ( TAF [ tid ] = True \to {B}^{′} [ tid ] = B [ tid ] TAF [ tid ] = False \to {B}^{′} [ tid ] = 0 )$$

where Tid is the set of all tuples ids in sⱼ, and

$${}_{tid ∈ Tid} ( f ( B ) [ tid ] = {\sum }_{i ∈ Tid ( tid )} {B}^{′} [ i ] )$$

where Tid(tid) is the set of tuple ids in sⱼ that have the same values for A₁, . . . , Aₙ as the tuple tid in Sᵢ.
If eᵢ is a constraint operation ξ[C](Rⱼ), where 1≦j<i, then Qᵢ is constructed by taking sᵢ=sⱼ, Vᵢ=Vᵢ₋₁, and Cᵢ is the conjunction of Cᵢ₋₁ and

$${}_{tid ∈ Tid} ( {C}^{′} [ tid ] )$$

where Tid is the set of all tuple ids in sⱼ, and C′[tid] is the constraint constructed from C by replacing every attribute A with the CVN variable A[tid].

Finally, for an optimization operator ω[min](Rⱼ), where 1≦j<n and eⱼ is an expression that returns a table with a single value (i.e., the value over the single attribute of the single tuple), then it is encoded as the following MP optimization problem: Let v be a CVN variable (or a constant) corresponding to the single value in sⱼ. Then, the following minimization problem can be constructed as follows:

min v subject to Cₙ₋₁

For the case of ω[max](Rⱼ), the reduction is the same, except that min is replaced with max. Finally, if the operator is ω[sat](Rⱼ), where sat is a keyword that indicates that interest is only in satisfiability (not optimization), the problem constructed is one that finds a feasible instantiation to variables in Vₙ₋₁.

The following is a formal proof of correctness for both Theorem 1 and Theorem 2.

Proof 1 First, extend the definition of correct reduction to partial reduction as follows. A partial reduction ({s₁, . . . , sᵢ}, Vᵢ, Cᵢ) for 1≦i≦n of a DGQL query R₁=e₁; . . . ; Rₙ=eₙ; ω is correct if:

Soundness
Every reduction instantiation (r₁, . . . , rᵢ) of (s₁, . . . , sᵢ) that satisfies constraint Cᵢ is indeed a partial feasible execution path of the DGQL query; and

Completeness
Every partial feasible execution path (r₁, . . . , rᵢ) is a reduction instantiation of (s₁, . . . , sᵢ) that satisfies Cᵢ.

Note, that when i=0, the partial reduction is ({ }, V₀=Ø, C₀=True) and is defined to be correct. Also note that the correct partial reduction for i=n is exactly the correct reduction.

Proof of the correctness of partial constraint reduction for every 1≦i≦n is provided by induction on i. For i=0 the reduction is correct by definition. Inductively, assuming correctness of reduction ({s₁, . . . , sᵢ₋₁}, Vᵢ₋₁, Cᵢ₋₁) proof of correctness for reduction ({s₁, . . . , sᵢ}, Vᵢ, Cᵢ).

To prove soundness, let (r₁, . . . , rᵢ) be a reduction instantiation of ({s₁, . . . , sᵢ}, Vᵢ, Cᵢ}), It can be considered that (r₁, . . . , rᵢ) is a partial feasible execution path. Clearly, (r₁, . . . rᵢ₋₁) constitutes a reduction instantiation of ({s₁, . . . , sᵢ₋₁}, Vᵢ₋₁, Cᵢ₋₁). Therefore, by induction hypothesis, (r₁, . . . , rᵢ₋₁) is a partial feasible execution path.

To prove that (r₁, . . . , rᵢ) is a partial feasible execution path, consider cases below corresponding to the cases of the formal reduction of Rᵢ=eᵢ:
Case 1: eᵢ is a base relational table r. Since the constraints added by sᵢ are of the form TAF[tid]=True they are all satisfied and rᵢ=r. Therefore (r₁, . . . , rᵢ) is a partial feasible execution path.
Case 2: eᵢ is a previously assigned relational name Rⱼ, 1≦j<i. Since Cᵢ=Cᵢ₋₁, rᵢ=rⱼ and therefore, (r₁, . . . , rᵢ) is a partial feasible execution path.
Case 3: eᵢ is an augmentation-from-domain α[AεD](Rⱼ), 1≦j<i. Since Cᵢ=Cᵢ₋₁, rᵢ is an augmentation of rⱼ and therefore (r₁, . . . , rᵢ) is a partial feasible execution path.
Case 4: eᵢ is an augmentation-from-relation α[A₁, . . . , AₘεRⱼ](Rₖ), where 1≦j, k<i. Since the constraints added to Cᵢ₋₁ to form Cᵢ must be satisfied, the table rᵢ constructed as the reduction instantiation, is also an augmentation of rₖ. Therefore, (r₁, . . . , rᵢ) is a partial feasible execution path.
Case 5: eᵢ is a projection operation RJR), where 1≦j<i. Since Cᵢ=Cᵢ₋₁, clearly reduction instantiation rᵢ is a projection of rⱼ, and therefore (r₁, . . . , rᵢ) is a partial feasible execution path.
Case 6: eᵢ is an intersection operation Rⱼ∩Rₖ, where 1≦j, k<i. The constraints added to Cᵢ₋₁ to form Cᵢ make sure that the pairs of tuples that make TAF variable True are exactly those that are equal to each other and, therefore, must be in the intersection. Therefore, the reduction instantiation rᵢ is indeed the intersection of rⱼ and rₖ, and thus (r₁, . . . , rᵢ) is a partial feasible execution path.
Case 7: eᵢ is a set difference operation Rⱼ−Rₖ, where 1≦j, k<i. The constraints added to Cᵢ₋₁ to form Cᵢ guarantee that in the instantiation of sᵢ, the tuples with TAF=True are exactly the tuples in rⱼ but not in rₖ. Therefore, the reduction instantiation rᵢ is exactly rⱼ−rₖ, and thus (r₁, . . . , rᵢ) is a partial feasible execution path.
Case 8: eᵢ is a Cartesian product Rⱼ×Rₖ, where 1≦j, k<i. The constraints added to Cᵢ₋₁ to form Cᵢ guarantee that in the instantiation of sᵢ, the tuples with TAF=True are exactly those tuples composed from a pair of tuples with the corresponding TAF being True. Therefore, the reduction instantiation rᵢ is exactly the Cartesian product rⱼ×rₖ, and thus (r₁, . . . , rᵢ) is a partial feasible execution path.
Case 9: eᵢ is selection operation σ_{P}(Rⱼ), where 1≦j<i and P is the selection predicate. The constraints added to Cᵢ₋₁ to form Cᵢ guarantee that the tuples in the instantiation of sᵢ with TAF=True are exactly those that satisfy the selection condition. Therefore, the reduction instantiation rᵢ=σ_{P}(rⱼ), and thus (r₁, . . . , rᵢ) is a partial feasible execution path.
Case 10: eᵢ is an aggregation δ[A₁, . . . , Aₙ, ƒ(B)](Rⱼ), 1≦j<i. The constraints added to Cᵢ₋₁ to form Cᵢ guarantee that the reduction instantiation rᵢ is exactly the aggregation of δ[A₁, . . . , Aₙ, ƒ(B)](rⱼ). Therefore, (r₁, . . . , rᵢ) is a partial feasible execution path.
Case 11: eᵢ is a constraint operation ξ[C](Rⱼ), where 1≦j<i. The constraints added to Cᵢ₋₁ to form Cᵢ are exactly those that express C. Therefore, since Cᵢ is satisfied, the reduction instantiation rᵢ satisfies C, and thus (r₁, . . . , rᵢ) is a partial feasible execution path.

In all cases of the formal reduction (r₁, . . . , rᵢ) is a partial feasible execution path. Therefore Theorem 1 is sound.

To prove completeness, let (r₁, . . . , rᵢ) be a partial feasible execution path. Considering that (r₁, . . . , rᵢ) is also a reduction instantiation of ({s₁, . . . , sᵢ}, Vᵢ, Cᵢ). Clearly, (r₁, . . . , rᵢ₋₁) is a partial feasible execution path. Therefore, by the induction hypothesis, (r₁, . . . , rᵢ₋₁) is also a reduction instantiation of ({s₁, . . . , sᵢ₋₁}, Vᵢ₋₁, Cᵢ₋₁).

To prove that (r₁, . . . , rᵢ) is a reduction instantiation of ({s₁, . . . , sᵢ}, Vᵢ, Cᵢ), consider cases below corresponding to the cases of the formal reduction Rᵢ=eᵢ.
Case 1: eᵢ is a base relational table r. Since rᵢ=r, rᵢ is a reduction instantiation of sᵢ when all TAF variables are True, and thus (r₁, . . . , rᵢ) is a reduction instantiation of ({s₁, . . . , sᵢ}, Vᵢ, Cᵢ)
Case 2: eᵢ is a previously assigned relational name Rⱼ, 1≦j<i. Since Cᵢ=Cᵢ₋₁, rᵢ=rⱼ, and rⱼ is a reduction instantiation of sⱼ, rᵢ is a reduction instantiation of sⱼ. Thus, (r₁, . . . , rᵢ) is a reduction instantiation of ({s₁, . . . , sᵢ}, Vᵢ, Cᵢ).
Case 3: eᵢ is an augmentation-from-domain α[AεD](Rⱼ), 1≦j<i. Since Cᵢ=Cᵢ₋₁, and rᵢ is an augmentation from domain of rⱼ, rᵢ is a reduction instantiation in which new variables in Vᵢ are instantiated with values from the augmentation. Thus, (r₁, . . . , rᵢ) is a reduction instantiation of ({s₁, . . . , sᵢ}, Vᵢ, Cᵢ).
Case 4: eᵢ is an augmentation-from-relation α[A₁, . . . , AₘεRⱼ](Rₖ), where 1≦j, k<i. Since rᵢ is an augmentation from relation of rₖ, the corresponding instantiation of values into new variables in Vᵢ must satisfy the constraints added to Cᵢ₋₁ to form Cᵢ. Therefore, rᵢ is a reduction instantiation of sᵢ. Thus, (r₁, . . . , rᵢ) is a reduction instantiation of ({s₁, . . . , sᵢ}, Vᵢ, Cᵢ).
Case 5: eᵢ is a projection operation π_{L}(Rⱼ), where 1≦j<i. Since Cᵢ=Cᵢ₋₁, the instantiation of values that corresponds to rⱼ satisfies Cᵢ. Therefore, rᵢ is a reduction instantiation of sᵢ, and (r₁, . . . , rᵢ) is a reduction instantiation of ({s₁, . . . , sᵢ}, Vᵢ, Cᵢ).
Case 6: eᵢ is an intersection operation R₁∩Rₖ, where 1≦j, k<i. The constraints added to Cᵢ₋₁ to form Cᵢ make sure that the pairs of tuples that make TAF variable True are exactly those that are equal to each other and, therefore, must be in the intersection. Since rᵢ=π_{L}(rⱼ), the variable instantiation corresponding to rᵢ must satisfy the constraints added to Cᵢ₋₁ to form Cᵢ, and so rᵢ is reduction instantiation of sᵢ. Thus, (r₁, . . . , rᵢ) is a reduction instantiation of ({s₁, . . . , sᵢ}, Vᵢ, Cᵢ).
Case 7: eᵢ is a set difference operation Rⱼ−Rₖ, where 1≦j, k<i. The constraints added to Cᵢ₋₁ to form Cᵢ guarantee that in the instantiation of sᵢ, the tuples with TAF=True are exactly the tuples in rⱼ but not in rₖ. Since rᵢ=rⱼ−rₖ, variable instantiation corresponding to rᵢ must satisfy the constraints added to Cᵢ₋₁ to form Cᵢ, and so rᵢ is reduction instantiation of sᵢ. Thus, (r₁, . . . , rᵢ) is a reduction instantiation of ({s₁, . . . , sᵢ}, Vᵢ, Cᵢ).
Case 8: eᵢ is a Cartesian product Rⱼ×Rₖ, where 1≦j, k<i. The constraints added to Cᵢ₋₁ to form Cᵢ guarantee that in the instantiation of sᵢ, the tuples with TAF=True are exactly those tuples composed from a pair of tuples with the corresponding TAF's being True. Since rᵢ=rⱼ×rₖ, the variable instantiation corresponding to rᵢ must satisfy the constraints added to Cᵢ₋₁ to form Cᵢ, and so rᵢ is reduction instantiation of sᵢ. Thus, (r₁, . . . , rᵢ) is a reduction instantiation of ({s₁, . . . , sᵢ}, Vᵢ, Cᵢ).
Case 9: eᵢ is selection operation σ_{P}(Rⱼ), where 1≦j<i and P is the selection predicate. The constraints added to Cᵢ₋₁ to form Cᵢ guarantee that the tuples in the instantiation of sᵢ with TAF=True are exactly those that satisfy the selection condition. Since rᵢ=σ_{P}(Rⱼ), the variable instantiation corresponding to rᵢ must satisfy the constraints added to Cᵢ₋₁ to form Cᵢ and so rᵢ is reduction instantiation of sᵢ. Thus, (r₁, . . . , rᵢ) is a reduction instantiation of ({s₁, . . . , sᵢ}, Vᵢ, Cᵢ).
Case 10: eᵢ is an aggregation δ[A₁, . . . , Aₙ, ƒ(B)](Rⱼ), 1≦j<i. The constraints added to Cᵢ₋₁ to form Cᵢ guarantee that the reduction instantiation rᵢ is exactly the aggregation of δ[A₁, . . . , Aₙ, ƒ(B)](rⱼ). Since rᵢ=δ[A₁, . . . , Aₙ, ƒ(B)](rⱼ), the variable instantiation corresponding to rᵢ must satisfy the constraints added to Cᵢ₋₁ to form Cᵢ, and so rᵢ is reduction instantiation of sᵢ. Thus, (r₁, . . . , rᵢ) is a reduction instantiation of ({s₁, . . . , sᵢ}, Vᵢ, Cᵢ).
Case 11: eᵢ is a constraint operation ξ[C](Rⱼ), where 1≦j<i. The constraints added to Cᵢ₋₁ to form Cᵢ are exactly those that express C. Since rᵢ must satisfy C to form a partial feasible execution path, the variable instantiation corresponding to rᵢ must satisfy Cᵢ, and so rᵢ is a reduction instantiation of sᵢ. Thus, (r₁, . . . , rᵢ) is a reduction instantiation of ({s₁, . . . , sᵢ}, Vᵢ, Cᵢ).

In all cases of the formal reduction, (r₁, . . . , rᵢ) is a reduction instantiation of ({s₁, . . . , sᵢ}, Vᵢ, Cᵢ). Therefore Theorem 1 is sound.

Proof 2 Let ({s₁, . . . , sₙ}, V, C) be the reduction produced by applying Algorithm 1 to the DGQL query R₁=e₁; . . . ; Rₙ=eₙ; ω. Assume that the constraints C are feasible (otherwise Algorithm 2 returns ⊥ which is correct). Considering the following three cases:
Case 1: ω=sat. The constraints C and variables V make up a Constraint Satisfaction Problem. Because C is feasible, applying a CSP solver will produce an assignment of variables in V that satisfies C. Apply the steps in Definition 6 to get the reduction instantiation (r₁, . . . , rₙ). By Theorem 1 every reduction instantiation is a feasible execution path, thus (r₁, . . . , rₙ) is correct.
Case 2: ω=min(Rₖ). The expression Rₖ returns a single numeric value that is held in the variable V_{R}_{ₖ}. This is the objective in the Mathematical Programming problem: min V_{R}_{ₖ} s.t. C. Because C is feasible, applying an MP solver will produce an assignment of variables in V that satisfies C such that V_{R}_{ₖ} is minimum. Apply the steps in Definition 6 to get the reduction instantiation (r₁, . . . , rₙ). By Theorem 1 every reduction instantiation is a feasible execution path. Assume that rⱼ is not the minimal value over all feasible execution paths. Then the reduction instantiation is not minimal which contradicts the fact the MP solver found the minimal Thus (r₁, . . . , rₙ) is correct.
Case 3: ω=max(Rₖ). This follows from the proof of Case 2 and the observation that max V_{R}_{ₖ} s.t. C is equivalent to min −V_{R}_{ₖ} s.t. C.

The DGQL syntax and semantics is informally explained using a manufacturing example. Consider the problem of a complex manufacturing process, in which a number of products need to be manufactured. Each product can be produced by one or more assembly processes, where each assembly is composed of several machines working in parallel, as shown in Appendix A. For the required demand of the output products, a decision must be made on how much should be produced by each assembly, which machines should be on and their level of operation. Operation of each machine has associated cost, which is a function of the machine output level, which often has an S shape, indicating less efficient operation at the edges of its operational range, and more efficient operation at its “sweet spot”. In turn, each assembly requires sub-products as its input, and those in turn are produced by other assemblies. Thus the overall manufacturing process may involve multiple layers of assemblies. An important question is how to make the production decision that minimizes the total production cost.

To understand the semantics, consider first a database that contains the following tables:

product(id,demand):
a tuple indicating that the quantity demand of product id is requested.
   assembly(id,output):
a tuple indicating that machines in assembly id produce the product output.
   resource(assembly,input,amount):
a tuple indicating that machines in assembly require quantity amount of product input to produce one unit of output.
   machine(id,assembly,min,max,active,qty,c0,c1,c2,c3):
a tuple indicating machine id can produce between min and max of product output with cost c3*qty3+c2*qty2+c1*qty+c0 if active is True or will produce nothing (i.e., qty=0) if active is False.

It is noted that the resource table may contain more than one row with the same assembly. This corresponds to the machines in that assembly requiring more than one input product to produce the output product. Raw materials used in the earliest stage that do not come from a manufacturing process can be encoded by adding an assembly that has no entries in the resource table and contains a single machine with a potentially zero cost function.

Assuming, initially, that the operations manager has decided upon a production plan, and the columns active and qty of table machine contain the correct values. It is then possible to develop a simple database reporting application that computes the cost of this production plan with the following SQL:

```
CREATE VIEW machine_production AS
  SELECT id,assembly,
    CASE WHEN active
      THEN qty
      ELSE 0
    END AS produced,
    CASE WHEN active
      THEN c3*qty\hat{ }3 + c2*qty\hat{ }2 + c1*qty + c0
      ELSE 0
    END AS cost
  FROM machine;
CREATE VIEW total_cost AS
  SELECT SUM(cost) FROM machine_production;
```

It is noted that the cost computation above is completely independent of the product demand and is based solely on the configuration decisions of the operations manager. To extend this database application to include a report on how much product was produced versus the demand requested, add the following additional SQL:

```
CREATE VIEW assembly_production AS
  SELECT a.id,a.product,
    SUM(mp.produced) AS produced
  FROM assembly a
  LEFT JOIN machine_production mp
    ON mp.assembly=a.id
  GROUP BY a.id,a.product;
CREATE VIEW product_production AS
  SELECT p.id,p.demand,
    SUM(ap.produced) AS produced
  FROM product p
  LEFT JOIN assembly_production ap
    ON p.id=ap.product
  GROUP BY p.id,p.demand;
CREATE VIEW demand_vs_produced AS
  SELECT pp.id,pp.produced,
    pp.demand+SUM(ap.produced*r.amount) AS demand
  FROM product_production pp
  LEFT JOIN assembly_production ap
    ON ap.product=pp.id
  LEFT JOIN resource r
    ON r.assembly=ap.id AND r.product=pp.id
  GROUP BY pp.id,pp.produced,pp demand;
```

The operations manager can then use the report from view demand versus produced to check that the amount produced for each product does indeed exceed the requested demand Now assuming that rather than use trial and error, the operations manager would like the system to recommend the best production plan, i.e., to suggest values for the columns active and qty of table machine. This is needed so that the total_cost is minimized while the amount of products produced satisfies the requested demand. As previously discussed, the Decision Guidance Query Language (DGQL) designed with this goal in mind, as an extension to SQL for precisely describing optimization semantics on top of an existing database reporting application.

To turn the above pure SQL implementation into an optimization query, the following DGQL annotations are applied:

VARIABLE active ON machine;
VARIABLE qty>=0 ON machine;
CONSTRAINT NOT active OR
min <= qty AND qty <= max ON machine;
CONSTRAINT produced >= demand ON demand_vs_produced;

The VARIABLE annotations indicate that the columns active and qty on table machine are not provided, but rather are open variables that DGQL should provide values for. The CONSTRAINT annotations indicate that for each row of machine and demand versus produced the given SQL fragment should evaluate to True. This is identical to the CHECK constraint semantics for tables in the SQL language specification. While it is possible to reuse the SQL CHECK constraint on the table machine, implementation of integrity constraints on database views is not uniformly present in DBMS systems, and is therefore explicitly added in DGQL.

Finally, specify the optimization objective. In DGQL this is done using the command:

MINIMIZE total_cost;

The semantics of MINIMIZE is to instantiate values for active and qty of every row in table orders (in general, all tables with variables are instantiated), in a way such that the objective computed in total_cost is minimum among all possible configurations of operational machines and produced quantities.

To solve the optimization problem above, DGQL automatically translates the program into a formal mathematical programming problem. This is done using the DGQL reduction-algorithm.

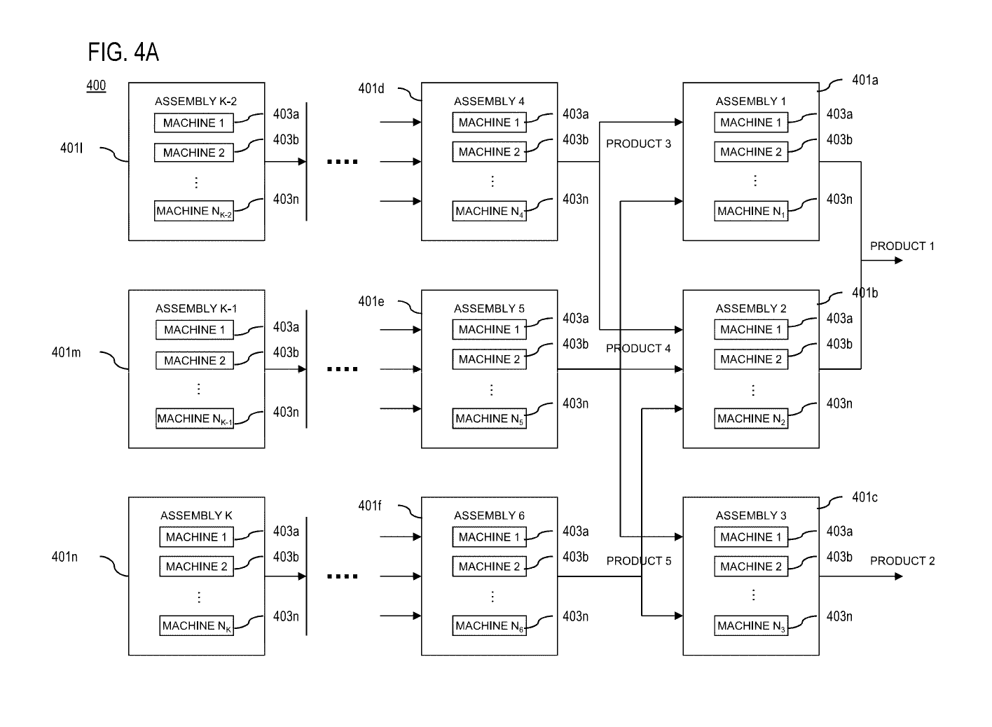

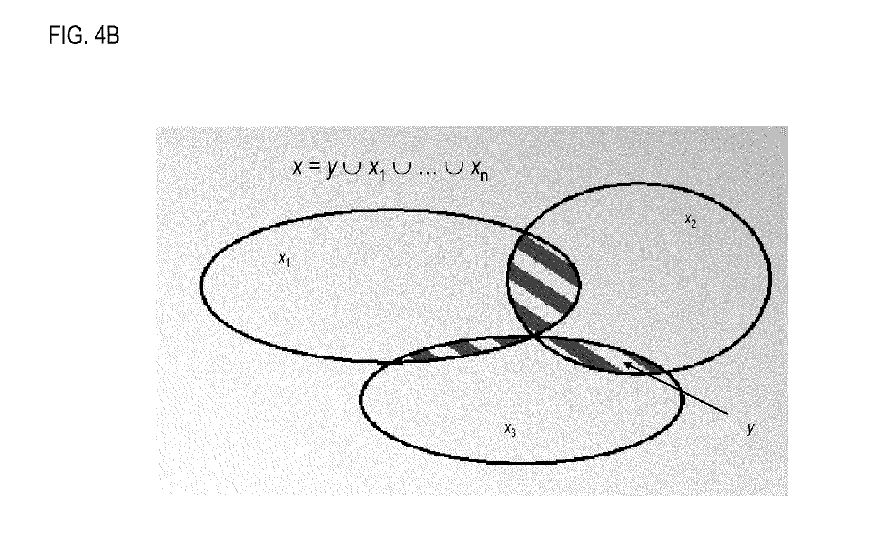

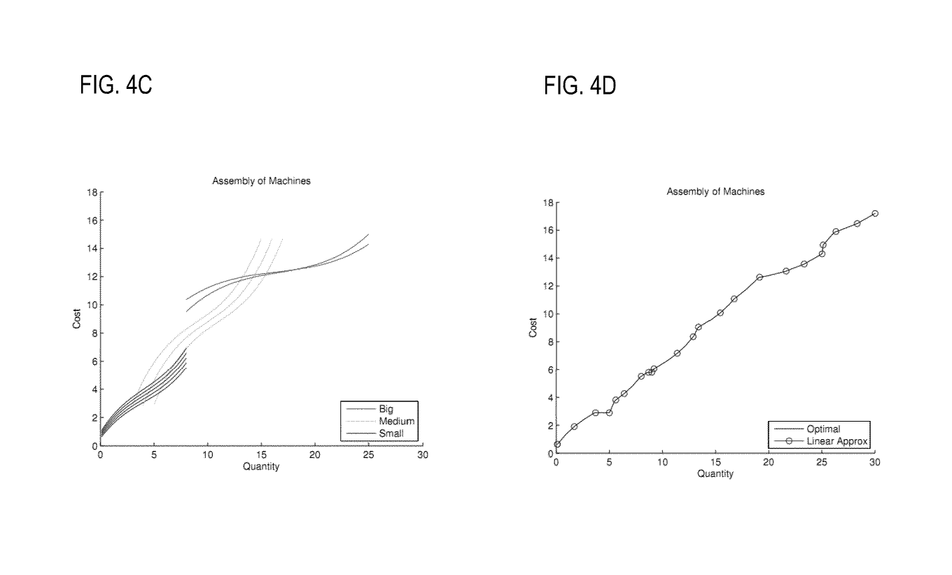

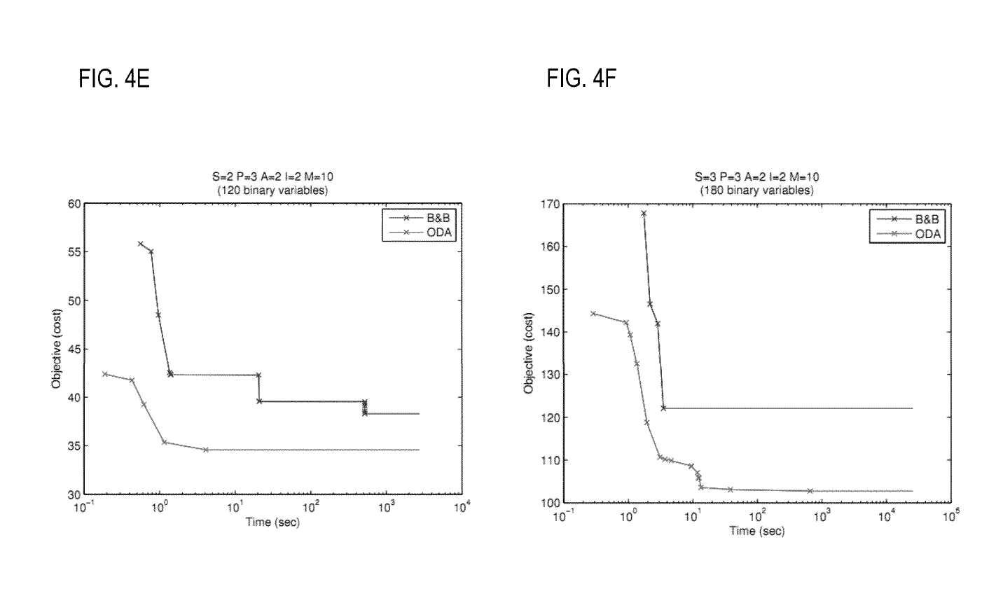

FIG. 4A is a diagram illustrating a utilization of the sub-process, for example, the pre-process (process 260) in a machine production environment, according to one embodiment. By way of example, in a Multistage Production Network (MPN) 400, number of products needs to be manufactured and each product is produced by one or more assembly node 401a-401n (collectively, assembly node 401) processes (e.g., Assembly 1-Assembly k), where each assembly node 401 is composed of several machines 403a-403n (collectively, machine 403) working in parallel. For the demand of the output products, a decision needs to be made on how much should be produced by each MPN assembly node 401 (e.g., which machine should be on and what should be the machine's output level). Operation of each machine 403 has associated cost, which is associated with the machine output level. In turn, each MPN assembly node 401 may need sub-products as its input, and those in turn are produced by other assembly nodes 401. Thus, the overall MPN 400 involves multiple layers of MPN assembly nodes 401. Here, production decisions that minimize the total production cost needs to be made. In one embodiment, linear or piece-wise linear arithmetic constraints may be used in expressing machines 403′ cost functions and limitations. Then, the MPN problem may be formulated and solved using Mixed Integer Linear programming (MILP).

In one embodiment, the optimization platform 103 may use an Online Decomposition Algorithm (ODA) which leverage the fact that in MPN-like problems, only a part of the problem is dynamic (e.g., the demand for the output product) whereas the rest of the problem is static (e.g., the connectivity graph of the assemblies and the cost function of machines). The optimization platform 103 may perform, by using the ODA, pre-processing of the static parts of the problem in order to speed-up the online optimization. During the pre-processing, the optimization platform 103 may optimize each assembly node 401 for discredited values of possible output, and approximate the aggregated cost functions for optimal selection of machines 403. Then, optimization platform 103 may use the approximated cost functions to decompose the original problem to smaller problems, and utilize search heuristics based on pre-processed look-up tables for selection of operational machines 403.

In one embodiment. following equivalent form of the objective is considered:

```
var AsmCost {Assemblies} >=0;
minimize total_cost:
  sum{a in Assemblies} AsmCost[a];
subject to
  assembly_cost {a in Assemblies}:
    AsmCost[a] =
      sum{m in Machines} Production[a,m]*Cost[m];
```

In one embodiment, under this alternative form, the optimization problem can be rewritten as: min AsmCostal+ . . . +AsmCostan s:t: Restrictal ̂ . . . ̂ Restrictan ̂ RestrictProducts where Restrictai contains all the constraints in machine operation, machine cost, machine production, and assembly products that involve machines in assembly ai, and RestrictProducts contains the constraints in product production and demand vs produced. Note that the only link between Restrictai and RestrictProducts is the interface variables in AsmQty[a] and that AsmCostai is purely a function of AsmQty[a]. Thus this equivalent form has “decomposed” the problem so that Restrictai contains only static input parameters and all of the dynamic parameters Demand are contained only in RestrictProducts. The objective is now a function of the assembly cost alone. Intuitively, this optimization problem can broken down into components corresponding to each assembly. Each component contains variables that are used to describe the assembly configuration as well as variables that are used to capture global constraints and the objective function. The configuration variables, internal variables, and the variables that are used across components the interface variables may be called. Given the alternative form above, Active, Qty, Cost and MachQty are the internal variables and AsmQty and AsmCost are the interface variables. Again, other than computing the values for the interface variables, there are no references to the internal variables outside the component.

In one embodiment, this decomposition allows taking advantage of offline preprocessing. Generally, the proposed decomposition technique can be applied to any optimization problem so long as the following pre-computability conditions hold:

1) The optimization problem min f(̂x) s:t: C(̂x) is of the form (see FIG. 4B)

min f1(̂x1;̂y)+ . . . +fn(̂xn;̂y)

s:t: C1(̂x1;̂y)̂ . . . ̂Cn(̂xn;̂y)̂C0(̂y) (1)

where variables in ̂xi only appear in fi and Ci.
2) All dynamic parameters are contained only in C0(̂y).

In one embodiment, the set y represents the interface variables and the xi's are the internal variables. As in the running example, optimal values for the interface variables y and use the precomputed values for the internal variables to fix the combinatorial choices for each component need to be found. In the general case, we would like to reformulate (1) in terms of only y. This can be done by defining new component objective functions as:

$$F 1 {(}^{⋀} y ) = {min}^{⋀} x 1 f 1 {(}^{⋀} x 1 ; {}^{⋀} y ) \\ … \\ Fn {(}^{⋀} y ) = {min}^{⋀} xnfn ( {}^{⋀} xn ; {}^{⋀} y ) \qquad ( 2 )$$

Similarly the component constraints can be redefined as:

$$K 1 {(}^{⋀} y ) = ( 9 x 1 ) C 1 {(}^{⋀} x 1 ; {}^{⋀} y ) \\ … \\ Kn {(}^{⋀} y ) = ( 9 xn ) Cn ( {}^{⋀} xn ; {}^{⋀} y ) \qquad ( 3 )$$

In one embodiment, while both of these definitions are mathematically well defined, in practice F1(̂y), . . . , Fn(̂y) and K1(̂y), . . . , Kn(̂y) may not have a simple analytical form. Then the original problem in terms of Fi and Ki can be reformulated as follows:

min F1(̂y)+ . . . +Fn(̂y)

s:t: K1(̂y)̂ . . . ̂Kn(̂y)̂C0(̂y) (4)

In one embodiment, this reformulated problem is now only a function of the interface variables ̂y. A solution to (4) is a partial solution to the original problem (1). More formally, if ̂y_{—} is a solution to (4) then there exists a solution (̂x_{—}1; . . . ; ̂x_n; ̂y_) to (4). Similarly the opposite is true: a solution to the original problem (1) gives a solution to (4). That is, if (̂x_{—}1; . . . ; ̂x_n; ̂y) is a solution to (1) then ̂y_{—} is a solution to (4). Given a solution ̂y_ to the reformulated problem (4), it is possible to “decompose” the large combinatorial problem in (1) into n smaller combinatorial problems which may have a considerably smaller search space and can be solved independently of each other.

$$min x 1 f 1 ( {x}^{⋀} 1 ; {y}^{⋀} \_ ) s \text{:t} : C 1 ( {x}^{⋀} 1 ; {y}^{⋀} \_ ) \\ … \\ min xnfn ( {x}^{⋀} n ; {y}^{⋀} \_ ) s \text{:t} : C n ( {x}^{⋀} n ; {y}^{⋀} \_ ) \qquad ( 5 )$$

In one embodiment, each of the n optimization problems in (5) is a function of only ̂ xi and ̂y. Note, however, that the variables ̂y_{—} in (5) are fixed with the solution to (4). We further claim that a solution to (4) with the solutions to (5) is a solution to the original problem (1). That is, if ̂y_{—} is a solution to (4) and ̂x_{—}1; . . . ; ̂x_n are solutions to the n optimization subproblems in (5) then (̂x_{—}1; . . . ; ̂x_n; ̂y_) is a solution to (1).

In one embodiment, the general reformulation above shows how any optimization problem that meets the pre-computability conditions can be “decomposed” into n optimization subproblems. Note that the claims made in this reformulation are only valid when the solutions to (4) and (5) are precise.

In one embodiment, the definitions for F1; . . . ; Fn and K1; . . . ; Kn may not have a simple analytical form that can be used with existing solver technologies (e.g., LP, MILP, QP, NLP, etc.). Thus while the decomposition above does in fact reduce the size of the combinatorial search space, it may produce problem formulations that cannot be solved directly.

In one embodiment, the approach taken with the online-decomposition algorithm is to use approximations for F1; . . . ; Fn and K1; . . . ; Kn that have an analytical form which can be solved in practice. Specifically, for the multistage production problem, assemblies 1; . . . ; n correspond to a pairs (F1; K1); . . . ; (Fn; Kn), where Fi is the cost function of assembly i (see FIGS. 4C and 4D) in terms of its output amount, say yi, and Ki is the constraint on the assembly's output, which is simply an interval constraint on yi. To produce an approximation Fi for assembly i, the range of output yi is discretized and, for each value in the range, the corresponding optimization problem in (2) is solved.

In one embodiment, a solution to Fi(yi) in (2) is an instantiation of all variables xi, including the binary variables that represent, for each machine in assembly i, whether it must be on or off (machine configuration). Thus, the result of the preprocessing for assembly i is a table that, for each discretized value of output yi, stores the value of Fi as well as the optimal machine configuration. The function Fi is then approximated using a continuous piece-wise linear function.

In one embodiment, solving (4) with the approximations of Fi's and Ki's produces an instantiation of variables ̂y=(y1; . . . ; yn), i.e., output value for each assembly. Given an output value y_i for assembly i, it can be looked at the preprocessing table for an entry y0 i that is “closest” to y_i, and identify the corresponding optimal machine configuration.

In one embodiment, if Fi and Ki approximation are precise, and y_i and y0i are equal or “sufficiently” close, the machine configuration in the preprocessing table would indeed be the optimal machine configuration of assembly i for the original problem (1). Assuming this were the case, our strategy would be to go back to the original problem (1), and instantiate all found (optimal) machine configurations (from the preprocessing table), thus simplifying the original problem to not include any binary variables at all! The solution to such simplified problem would be the optimal solution to the original problem (1).

In one embodiment, since the approximations are not precise, and since there are no guarantees that y_{—} i would be “sufficiently” close to y0 i, the idea behind the algorithm is this: machine configurations are enumerated in the preprocessing table for each assembly i according to the proximity of y_i to y0i. Then, a simple probabilistic algorithm is used to try out a small number of machine configurations of assemblies giving (exponential) preference to higher enumeration ranking. The resulting algorithm explores a tiny fraction of the original combinatorial search space, yet produces, as shown in the experimental results depicted in FIGS. 4E and 4F.

The processes described herein for providing optimization in data-driven environments may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide optimization in data-driven environments as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing optimization in data-driven environments.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to provide optimization in data-driven environments. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for providing optimization in data-driven environments. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing optimization in data-driven environments, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing optimization in data-driven environments to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

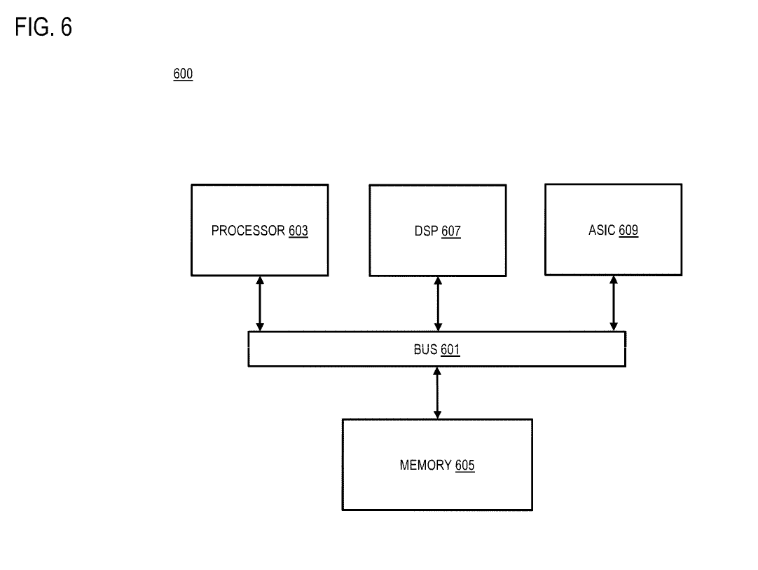

FIG. 6 illustrates a chip set or chip 600 upon which an embodiment of the invention may be implemented. Chip set 600 is programmed to provide optimization in data-driven environments as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of providing optimization in data-driven environments.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide optimization in data-driven environments. The memory 605 also stores the data associated with or generated by the execution of the inventive steps.

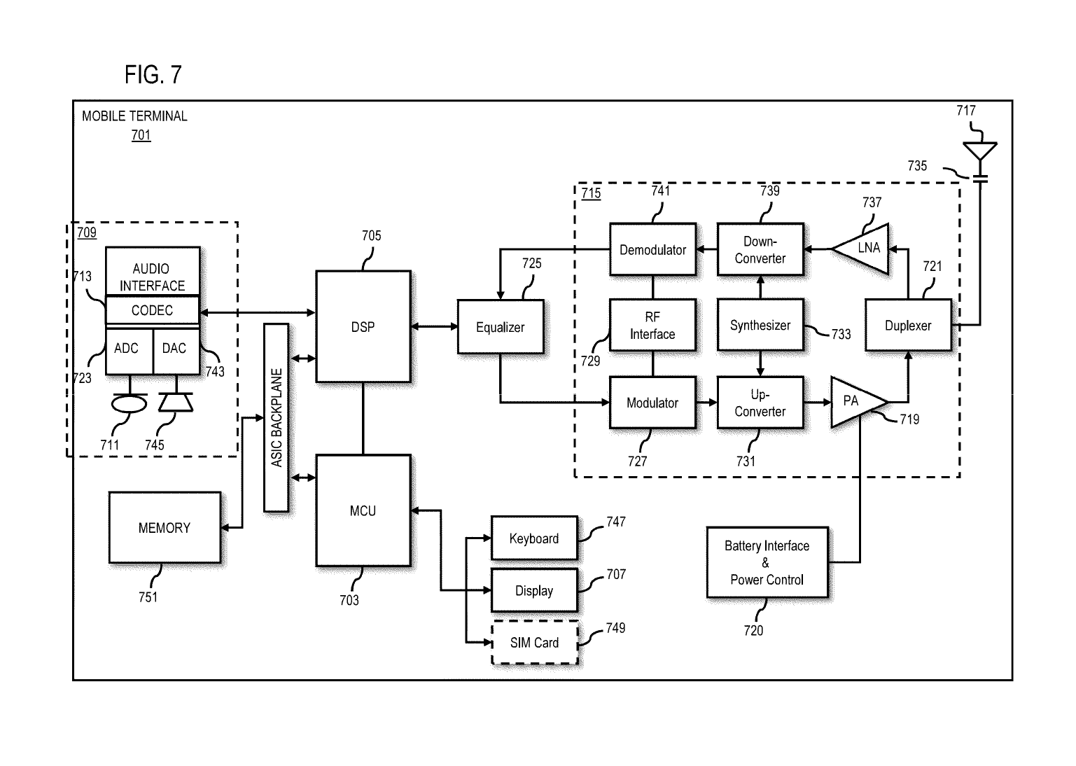

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of providing optimization in data-driven environments. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing optimization in data-driven environments. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide optimization in data-driven environments. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving one or more database queries expressing a computation objective;
determining a database model based, at least in part, on the computation objective;
annotating the database model with one or more variable attributes, one or more constraints, or a combination thereof;
converting the database model into one or more mathematical models based, at least in part, on the one or more variable attributes, the one or more constraints, or a combination thereof; and
determining one or more solutions based, at least in part, on the one or more mathematical models.

2. A method of claim 1, further comprising:
simplifying the one or more mathematical models by reducing the one or more variable attributes, rewriting the one or more constraints, removing one or more computations of the one or more mathematical models, or a combination thereof.

3. A method of claim 1, further comprising:
determining one or more mathematical solvers based on the database model, the one or more mathematical models, or a combination thereof.

4. A method of claim 3, wherein optimization by the one or more mathematic solvers are performed based, at least in part, on one or more user specified restraints.

5. A method of claim 3, further comprising:
converting the one or more mathematical models into a solver specific model; and
applying the one or more mathematical solver to the solver specific model.

6. A method of claim 1, further comprising:
determining whether the one or more mathematical models are capable of being solved based on one or more sub-process,
wherein the one or more sub-processes are associated with one or more approximations of one or more computations associated with the one or more mathematical models.

7. A method of claim 6, further comprising:
determining if the one or more approximations exist;
if the one or more approximations exist, replacing the one or more computations with the one or more approximations; and
determining the one or more sub-solutions based, at least in part, on the one or more approximations.

8. A method of claim 7, further comprising:
causing, at least in part, a simplification of the one or more mathematical models based on the one or more sub-solutions; and
determining a solution based on the one or more simplified mathematical models,
wherein the solution is refined based, at least in part, on the one or more sub-processes.

9. A method of claim 6, wherein the one or more sub-processes comprises:
identifying, from a lookup table, specific values for one or more variables of a computation associated with the one or more mathematical models;
determining an optimal value for the computation based, at least in part, on the specific values;
storing the optimal value in the lookup table; and
updating the one or more approximations with the optimal value.

10. A method of claim 7, wherein the one or more solution is optimized by repeating the determination based, at least in part, on one or more user-specified restraints.

11. An apparatus comprising:
a processor; and
a memory including computer program code for one or more programs,
the memory and the computer program code configured to, with the processor, cause the apparatus to perform the following,
receive one or more database queries expressing a computation objective;
determine a database model based, at least in part, on the computation objective;
annotate the database model with one or more variable attributes, one or more constraints, or a combination thereof;
convert the database model into one or more mathematical models based, at least in part, on the one or more variable attributes, the one or more constraints, or a combination thereof; and
determine one or more solutions based, at least in part, on the one or more mathematical models.

12. An apparatus of claim 11, wherein the apparatus is further caused to:
simplify the one or more mathematical models by reducing the one or more variable attributes, rewriting the one or more constraints, removing one or more computations of the one or more mathematical models, or a combination thereof.

13. An apparatus of claim 11, wherein the apparatus is further caused to:
determine one or more mathematical solvers based on the database model, the one or more mathematical models, or a combination thereof.

14. An apparatus of claim 13, wherein optimization by the one or more mathematic solvers are performed based, at least in part, on one or more user specified restraints.

15. An apparatus of claim 13, wherein the apparatus is further caused to:
convert the one or more mathematical models into a solver specific model; and
apply the one or more mathematical solver to the solver specific model.

16. An apparatus of claim 11, wherein the apparatus is further caused to:
determine whether the one or more mathematical models are capable of being solved based on one or more sub-processes,
wherein the one or more sub-processes are associated with one or more approximations of one or more computations associated with the one or more mathematical models.

17. An apparatus of claim 16, wherein the apparatus is further caused to:
determine if the one or more approximations exist;
if the one or more approximations exist, replace the one or more computations with the one or more approximations; and
determine the one or more sub-solutions based, at least in part, on the one or more approximations.

18. An apparatus of claim 17, wherein the apparatus is further caused to:
cause, at least in part, a simplification of the one or more mathematical models based on the one or more sub-solutions; and
determine a solution based on the one or more simplified mathematical models,
wherein the solution is refined based, at least in part, on the one or more sub-processes.

19. An apparatus of claim 16, wherein the one or more sub-processes cause the apparatus to:
identify, from a lookup table, specific values for one or more variables of a computation associated with the one or more mathematical models;
determine an optimal value for the computation based, at least in part, on the specific values;
store the optimal value in the lookup table; and
update the one or more approximations with the optimal value.

20. An apparatus of claim 17, wherein the one or more solution is optimized by repeating the determination based, at least in part, on one or more user-specified restraints.

21. A computer-readable storage medium carrying one or more sequences of one or more instructions which, when executed by one or more processors, cause an apparatus to at least perform the following steps:
receiving one or more database queries expressing a computation objective;
determining a database model based, at least in part, on the computation objective;
annotating the database model with one or more variable attributes, one or more constraints, or a combination thereof;
converting the database model into one or more mathematical models based, at least in part, on the one or more variable attributes, the one or more constraints, or a combination thereof; and
determining one or more solutions based, at least in part, on the one or more mathematical models.

22. A computer-readable storage medium of claim 21, wherein the apparatus is caused to further perform:
simplifying the one or more mathematical models by reducing the one or more variable attributes, rewriting the one or more constraints, removing one or more computations of the one or more mathematical models, or a combination thereof.

23. A computer-readable storage medium of claim 21, wherein the apparatus is caused to further perform:
determining one or more mathematical solvers based on the database model, the one or more mathematical models, or a combination thereof.

24. A computer-readable storage medium of claim 23, wherein optimization by the one or more mathematic solvers are performed based, at least in part, on one or more user specified restraints.

25. A computer-readable storage medium of claim 23, wherein the apparatus is caused to further perform:
converting the one or more mathematical models into a solver specific model; and
applying the one or more mathematical solver to the solver specific model.

26. A computer-readable storage medium of claim 21, wherein the apparatus is caused to further perform:
determining whether the one or more mathematical models are capable of being solved based on one or more sub-processes,
wherein the one or more sub-processes are associated with one or more approximations of one or more computations associated with the one or more mathematical models.

27. A computer-readable storage medium of claim 26, wherein the apparatus is caused to further perform:
determining if the one or more approximations exist;
if the one or more approximations exist, replacing the one or more computations with the one or more approximations; and
determining the one or more sub-solutions based, at least in part, on the one or more approximations.

28. A computer-readable storage medium of claim 27, wherein the apparatus is caused to further perform:
causing, at least in part, a simplification of the one or more mathematical models based on the one or more sub-solutions; and
determining a solution based on the one or more simplified mathematical models,
wherein the solution is refined based, at least in part, on the one or more sub-processes.

29. A computer-readable storage medium of claim 26, wherein the one or more sub-processes cause the apparatus to further perform:
identifying, from a lookup table, specific values for one or more variables of a computation associated with the one or more mathematical models;
determining an optimal value for the computation based, at least in part, on the specific values;
storing the optimal value in the lookup table; and
updating the one or more approximations with the optimal value.

30. A computer-readable storage medium of claim 27, wherein the one or more solution is optimized by repeating the determination based, at least in part, on one or more user-specified restraints.
